(19) United States
(12) Patent Application Publication
(10) Pub. No.: US 2024/0126304 A1
(43) Pub. Date: Apr. 18, 2024

(54) AUTOMATIC RECHARGING METHOD FOR AUTONOMOUS MOBILE DEVICE AND SYSTEM

(71) Applicant: Qfeeltech (Beijing) Co., Ltd., Beijing (CN)

(72) Inventors: Zhanglin LIU, Beijing (CN); Wulin TIAN, Beijing (CN)

(21) Appl. No.: 18/391,611

(22) Filed: Dec. 20, 2023

Related U.S. Application Data
(63) Continuation of application No. PCT/CN2022/089143, filed on Apr. 26, 2022.

(30) Foreign Application Priority Data
Jun. 22, 2021 (CN) 202110691406.9

(51) Int. Cl. G05D 1/661; G05D 1/247; H02J 7/00

(52) U.S. Cl. CPC G05D 1/661; G05D 1/247; H02J 7/0042

(57) ABSTRACT

The present disclosure provides an automatic recharging method for an autonomous mobile device and a system. The method includes: when the autonomous mobile device moves toward a charging base, receiving, by at least two receivers disposed on the autonomous mobile device, directional guidance signals transmitted by at least three transmitters disposed on the charging base. The method includes determining output signals corresponding to each receiver based on predetermined movement rules and the guidance signals received by each receiver. The predetermined movement rules include output signals corresponding to each receiver when each receiver receives different guidance signals. The method includes performing a vector composition on the output signals corresponding to the receivers to obtain a vector sum, and controlling movement of the autonomous mobile device based on the vector sum.

### CROSS-REFERENCE TO RELATED APPLICATIONS

This application is a continuation of International Application No. PCT/CN2022/089143, filed on Apr. 26, 2022, which claims priority to Chinese Patent Application No. 202110691406.9, filed on Jun. 22, 2021, in Chinese Patent Office, and titled “Automatic Recharging Method for Autonomous Mobile Device and System.” The entire contents of the above-references applications are incorporated herein by reference in this application.

### TECHNICAL FIELD

The present disclosure generally relates to the technical field of robots, and more specifically, to an automatic recharging method for an autonomous mobile device and a system.

### BACKGROUND

As the advance of technology in autonomous mobile devices, various autonomous mobile devices equipped with different functions have been developed, for example, autonomous cleaning mobile devices (e.g., smart floor sweeping robots, smart floor mopping robots, window cleaning robots), companion type autonomous mobile devices (e.g., smart electronic pets, nanny robots), service type autonomous mobile devices (e.g., receptionist robots in hotels, restaurants, meeting places), industrial inspection robots (e.g., power line inspection robots, smart forklift, etc.), security robots (e.g., home or commercial use smart safety robots), etc.

Currently, most autonomous mobile devices use battery as a power source. When the electric power is low, the autonomous mobile devices need to return to a charging base to perform battery charging (simply referred to as recharging). In the recharging process, sometimes even if the autonomous mobile device finds the charging base, the autonomous mobile device may not be able to accurately connect charging terminals (e.g., charging plates) on the autonomous mobile device with charging terminals (e.g., electrodes) on the charging base, causing a failure in the recharging.

### SUMMARY OF DISCLOSURE

The present disclosure provides an automatic recharging method for an autonomous mobile device and a system. When the autonomous mobile device detects a guidance signal transmitted by the charging base, the autonomous mobile device may accurately move to the charging base such that the charging plates of the autonomous mobile device and the electrodes on the charging base can be connected accurately (simply referred to as boarding the charging base), thereby realizing recharging successfully.

To achieve the above objective, embodiments of the present disclosure adopt the following technical solutions:

In a first aspect of the embodiments of the present disclosure, an automatic recharging method for an autonomous mobile device is provided.

The charging base is provided with at least three transmitters configured to transmit directional guidance signals. The guidance signals includes at least a first guidance signal, a second guidance signal, and a third guidance signal. A first transmitter, a second transmitter, and a third transmitter are configured to transmit the first guidance signal, the second guidance signal, and the third guidance signal, respectively. A projection of the second guidance signal on a horizontal plane and a projection of the third guidance signal on the horizontal plane are located at two sides of a projection of the first guidance signal on the horizontal plane. The autonomous mobile device is provided with at least two receivers configured to receive the guidance signals. The at least two receivers are disposed at the left and right sides of the autonomous mobile device, respectively. The method includes:
receiving, by the at least two receivers on the autonomous mobile device, the guidance signals;
determining an output signal corresponding to a receiver based on predetermined movement rules and a guidance signal received by the receiver, the predetermined movement rules including an output signal corresponding to each receiver when the receivers receive different guidance signals;
performing a vector composition on output signals corresponding to the receivers to obtain a vector sum, and controlling movement of the autonomous mobile device based on the vector sum.

In a second aspect of the embodiments of the present disclosure, an automatic recharging method for an autonomous mobile device is provided. The method includes:
the charging base is provided with a first transmitter configured to transmit directional guidance signals, the guidance signals include a first guidance signal; the autonomous mobile device is provided with at least two receivers configured to receive the guidance signals, the at least two receivers are disposed at two sides of the autonomous mobile device, respectively. The method includes:
receiving, by the at least two receivers on the autonomous mobile device, the guidance signals;
determining an output signal corresponding to a receiver based on a guidance signal received by the receiver based on predetermined movement rules and the guidance signal received by the receiver, the predetermined movement rules include an output signal corresponding to each receiver when the receivers receive different guidance signals;
performing a vector composition on output signals corresponding to the receivers to obtain a vector sum, and controlling movement of the autonomous mobile device based on the vector sum.

In a third aspect of the embodiments of the present disclosure, an autonomous mobile device system is provided. The autonomous mobile device system includes: an autonomous mobile device and a charging base;

The charging base is provided with at least three transmitters configured to transmit directional guidance signals. The guidance signals include a first guidance signal, a second guidance signal, and a third guidance signal. A first transmitter, a second transmitter, and a third transmitter are configured to transmit the first guidance signal, the second guidance signal, and the third guidance signal, respectively. A projection of the second guidance signal on a horizontal plane and a projection of the third guidance signal on the horizontal plane are located at two sides of a projection of the first guidance signal on the horizontal plane.

The autonomous mobile device is provided with at least two receivers configured to receive the guidance signals, the at least two receivers being disposed at two sides of the autonomous mobile device.

In a fourth aspect of the embodiments of the present disclosure, an electronic device is provided. The electronic device includes: at least one processor and a storage device;

the storage device is configured to store computer-executable instructions;

the at least one processor is configured to execute the computer-readable instructions stored in the storage device, to perform the automatic recharging methods for the autonomous mobile device according to the first aspect or the second aspect of the embodiments of the present disclosure.

In a fifth aspect of the embodiments of the present disclosure, a non-transitory computer-readable storage medium is provided. The computer-readable storage medium stores computer-executable instructions. When a processor executes the computer-executable instructions, the automatic recharging methods for the autonomous mobile device according to the first aspect or the second aspect of the embodiments of the present disclosure are performed.

Embodiments of the present disclosure provides an automatic recharging method for an autonomous mobile device and a system. When the autonomous mobile device moves toward a charging base, at least two receivers disposed on the autonomous mobile device may receive directional guidance signals transmitted by transmitters on the charging base. The guidance signals include at least a first guidance signal, a second guidance signal, and a third guidance signal. The charging base is provided with at least three transmitters, a first transmitter, a second transmitter, and a third transmitter, which are configured to transmit the first guidance signal, the second guidance signal, and the third guidance signal, respectively. A projection of the second guidance signal on a horizontal plane and a projection of the third guidance signal on the horizontal plane are located at two sides of a projection of the first guidance signal on the horizontal plane. The at least two receivers are disposed at the left and right sides of the autonomous mobile device, respectively, such that at least one receiver of the autonomous mobile device can receive the directional guidance signals transmitted by the transmitters on the charging base, and the autonomous mobile device can be guided by the directional guidance signals to successfully dock with the charging base. In the automatic recharging method for the autonomous mobile device provided by the embodiments of the present disclosure, based on predetermined movement rules, because different receivers on the autonomous mobile device may correspond to different output signals when receiving different guidance signals, a vector composition may be performed on the output signals corresponding to the receivers to obtain a vector sum, and the autonomous mobile device may be controlled based on the vector sum to move toward the charging base, thereby realizing more accurate control of the pose of the autonomous mobile device, such that the autonomous mobile device can more accurately dock with the charging base.

In addition to the above-described technical issues addressed by the present disclosure, technical features forming the technical solutions, and benefits provided by the technical features of the technical solutions, other technical issues that can be addressed by the autonomous mobile device of the present disclosure, other technical features included in the technical solutions, and other benefits provided by these technical features, will be explained in detail in specific embodiments.

### BRIEF DESCRIPTION OF THE DRAWINGS

To explain more clearly the technical solutions of the present disclosure or of the existing technologies, the accompanying drawings that are used in the description of the embodiments or the existing technologies are briefly introduced. Obviously, the accompanying drawings described below show some embodiments of the present disclosure. For a person having ordinary skills in the art, other accompanying drawings may be obtained based on these accompanying drawings without expending creative effort.

FIG. 1 is a flowchart showing an automatic recharging method for an autonomous mobile device, according to an illustrative embodiment of the present disclosure;

FIG. 2a is a first schematic illustration of a receiver on the autonomous mobile device, according to an illustrative embodiment of the present disclosure;

FIG. 2b is a second schematic illustration of a receiver on the autonomous mobile device, according to an illustrative embodiment of the present disclosure;

FIG. 2c is a third schematic illustration of a receiver on the autonomous mobile device, according to an illustrative embodiment of the present disclosure;

FIG. 2d is a fourth schematic illustration of a receiver on the autonomous mobile device, according to an illustrative embodiment of the present disclosure;

FIG. 2e is a fifth schematic illustration of a receiver on the autonomous mobile device, according to an illustrative embodiment of the present disclosure;

FIG. 2f is a sixth schematic illustration of a receiver on the autonomous mobile device, according to an illustrative embodiment of the present disclosure;

FIG. 3a is a first schematic illustration of a guidance signal transmitted by a charging base, according to an illustrative embodiment of the present disclosure;

FIG. 3b is a second schematic illustration of a guidance signal transmitted by a charging base, according to an illustrative embodiment of the present disclosure;

FIGS. 4a-4e show a first application scene for the recharging method of the autonomous mobile device, according to an illustrative embodiment of the present disclosure;

FIGS. 5a-5d show a second application scene for the recharging method of the autonomous mobile device, according to an illustrative embodiment of the present disclosure;

FIGS. 6a-6c show a third application scene for the recharging method of the autonomous mobile device, according to an illustrative embodiment of the present disclosure;

FIGS. 7a-7d show a fourth application scene for the recharging method of the autonomous mobile device, according to an illustrative embodiment of the present disclosure;

FIG. 8 is a schematic illustration of a structure of an autonomous mobile device system, according to an illustrative embodiment of the present disclosure; and

FIG. 9 is a schematic illustration of a structure of an electronic device, according to an illustrative embodiment of the present disclosure.

### DETAILED DESCRIPTION

In order to make the objective, features, and advantages of the present disclosure clearer and easier to understand, next, with reference to the drawings of the embodiments of the present disclosure, the technical solutions of the embodiments of the present disclosure will be described clearly and comprehensively. The described embodiments are only some embodiments of the present disclosure, and are not all of the embodiments. Based on the embodiments of the present disclosure, a person having ordinary skills in the art can obtain other embodiments without spending creative effort, which all fall into the protection scope of the present disclosure.

In the method of the embodiments of the present disclosure, a plurality of guidance signal receivers (simply referred to as receivers, configured to receive guidance signals) are provided on the autonomous mobile device. The receivers receive a plurality of guidance signals transmitted by guidance signal transmitters (simply referred to as transmitters) provided on the charging base. Different receivers may receive the same or different guidance signals. The autonomous mobile device may be controlled based on predetermined movement rules (including moving direction and moving angular velocity) to rotate and perform subsequent movement. Specifically, each receiver on the autonomous mobile device may provide a corresponding output signal that corresponds to a received guidance signal. The output signal corresponding to the receiver is a signal indicating a moving direction and a moving angular velocity for the autonomous mobile device when the receiver receives the corresponding guidance signal, assuming that only this receiver receives the guidance signal. Correspondingly, the predetermined movement rules define the output signal corresponding to each receiver when each receiver receives each guidance signal, which may indicate output values of the moving direction and the moving angular velocity. Illustratively, the output signal may be an output value that has a positive or negative sign. The positive or negative sign represents an indication of the moving direction for the autonomous mobile device, e.g., a rotation direction (for example, the positive sign may represent counter-clockwise rotation, the negative sign may represent clock-wise rotation; for the convenience of description, the following descriptions use this definition in the present disclosure, but a person having ordinary skills in the art can understand that the definition may be reversed, i.e., the positive sign may represent the clock-wise rotation, and the negative sign may represent the counter-clock wise rotation). The magnitude of the output value, e.g., the absolute value of the output signal, may be positively proportional to the moving angular velocity (e.g., (moving angular velocity)=k (output value), where k is a constant; for the convenience of description, no unit is added to the output value in the present disclosure; in the present disclosure, the output value may be equated with the moving angular velocity). Finally, a vector sum may be calculated (similar to vector addition operation, therefore, is also referred to as vector composition) based on the output signals corresponding to the guidance signals received by all receivers at a certain time instance. The direction of the vector sum represents an overall moving direction for the autonomous mobile device, i.e., an overall rotation direction. The magnitude of the vector sum may be positively proportional to the overall moving angular velocity that is for the subsequent movement of the autonomous mobile device. For example, an actual angular velocity for the subsequent movement of the autonomous mobile device may be obtained by multiplying the vector sum with a coefficient k. Therefore, the subsequent movement of the autonomous mobile device may be controlled based on the direction and magnitude of the vector sum.

It should be noted that in the embodiments of the present disclosure, the number of guidance signal transmitted by the charging base is greater than or equal to 1, and the number of receivers disposed on the autonomous mobile device is greater than or equal to 2.

Next, the automatic recharging method for the autonomous mobile device under various application scenes as provided by embodiments of the present disclosure will be described in detail.

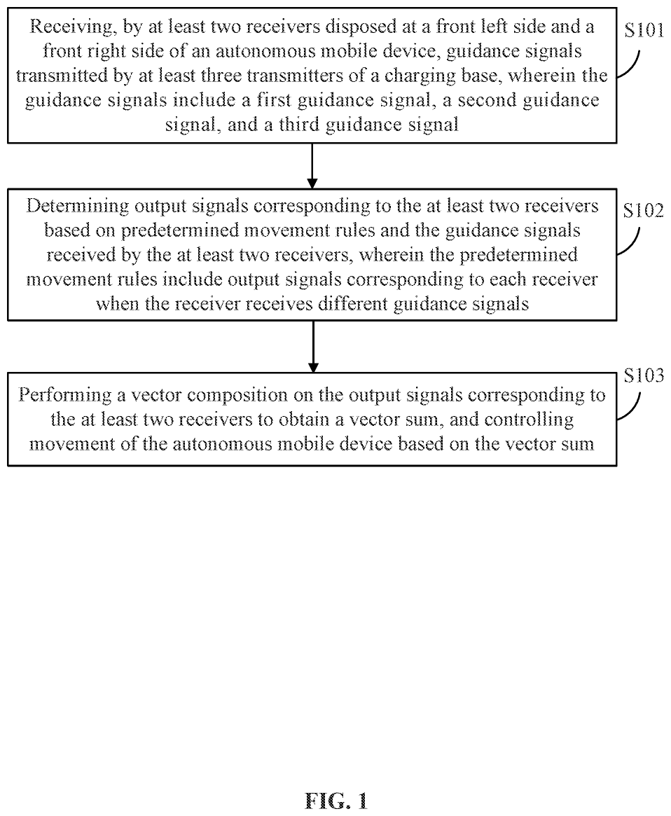

FIG. 1 is a flowchart showing an automatic recharging method for an autonomous mobile device according to an illustrative embodiment of the present disclosure. The execution body of the method of this embodiment may be a processor or a controller of the autonomous mobile device, or may be other devices having processing functions that may interact with the autonomous mobile device, such as a server, etc.

As shown in FIG. 1, the method provided by this embodiment may include the following steps.

S101, receiving, by at least two receivers disposed at a front left side and a front right side of an autonomous mobile device, guidance signals transmitted by at least three transmitters of a charging base, wherein the guidance signals include a first guidance signal, a second guidance signal, and a third guidance signal.

In this step, the charging base may be provided with at least three transmitters configured to transmit directional guidance signals. The guidance signals may include at least a first guidance signal, a second guidance signal, and a third guidance signal. A first transmitter, a second transmitter, and a third transmitter may transmit the first guidance signal, the second guidance signal, and the third guidance signal, respectively. The location relationship between the three guidance signals may be: a projection of the second guidance signal on a horizontal plane and a projection of the third guidance signal on the horizontal plane are located at two sides of a projection of the first guidance signal on the horizontal plane.

It should be noted that for the convenience of description and for the consistency of in the context, the location relationship between the first guidance signal, the second guidance signal, and the third guidance signal may also be equivalently described as: the second guidance signal and the third guidance signal are located at two sides of the first guidance signal.

In this step, the autonomous mobile device may be provided with at least two receivers. The at least two receivers may be disposed at the left and right sides of the autonomous mobile device, such that at least one receiver is disposed at each side of the left and right sides of the autonomous mobile device. For example, the autonomous mobile device may be provided with two receivers, and the two receivers may be disposed at the front left side and front right side of the autonomous mobile device, such that a receiver is disposed at each of the left and right sides of the autonomous mobile device. As another example, the autonomous mobile device may be provided with three receivers. One of the three receivers may be disposed at the left side of the autonomous mobile device, and the other two receivers may be disposed at the right side of the autonomous mobile device, such that at least one receiver is disposed at each of the left and right sides of the autonomous mobile device.

It should be noted that the number of receivers disposed on the autonomous mobile device is only for illustrative purposes. In actual applications, the number of receivers may be 4, 6, 8, etc., or may be odd numbers, such as 3, 5, etc., which is not limited by the present disclosure.

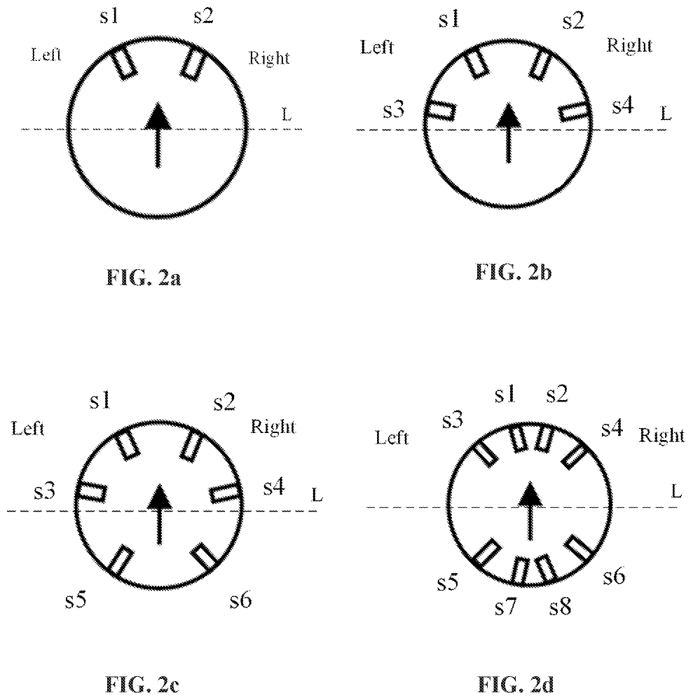

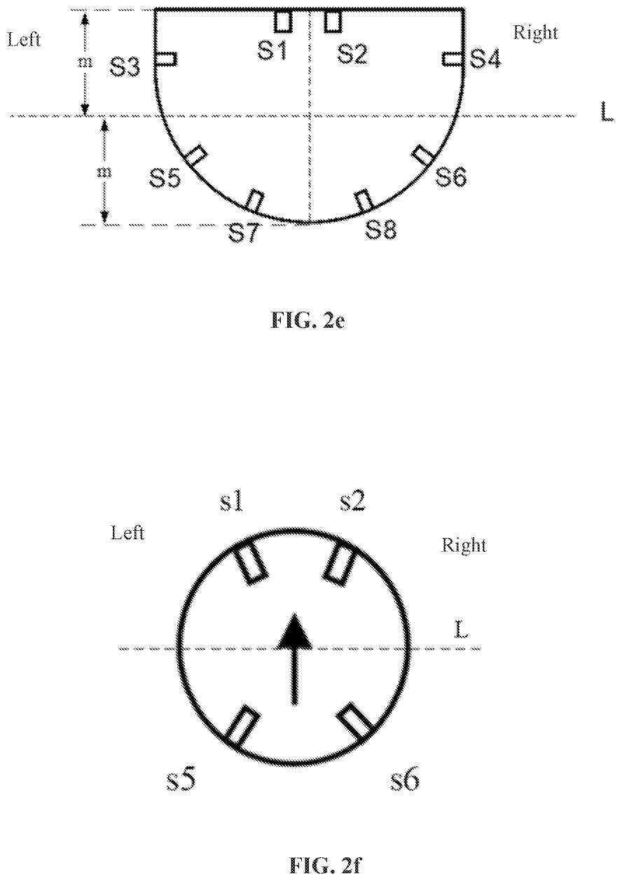

It should be noted that, in the embodiments of the present disclosure, the front and rear portions of the autonomous mobile device are defined as, using a central axis of the autonomous mobile device as a border, a half of the autonomous mobile device in the forward moving direction is the front portion, another half of the autonomous mobile device in the backward moving direction is the rear portion. In the present disclosure, the central axis of the autonomous mobile device is a virtual line perpendicular to the forward moving direction of the autonomous mobile device, which divides the autonomous mobile device into the front half portion and the rear half portion. Illustratively, the central axis may be a virtual line that is defined based on the geometric center or mass center. For example, as shown in FIGS. 2a-2d, the dashed line L is the central axis of the autonomous mobile device. Alternatively, the central axis may be defined as a virtual line having a same distance (distance m) with a foremost portion of a housing of the autonomous mobile device and with a rearmost portion of the housing of the autonomous mobile device, which is shown as the dashed line L in the D-shaped autonomous mobile device shown in FIG. 2e. The forward moving direction of the autonomous mobile device is shown in FIGS. 2a-2d, i.e., the direction indicated by the arrow, which is the moving direction of the autonomous mobile device during a normal movement. The “normal movement” refers to a movement when the autonomous mobile device executes a task, which is different from abnormal movements such as backward movement or swing movement when the autonomous mobile device operates in a predicament avoidance mode. Illustratively, the front portion of the autonomous mobile device in FIG. 2a to FIG. 2e is the half above the central axis L, the rear portion of the autonomous mobile device in FIG. 2a to FIG. 2e is the half below the central axis L.

Specifically, when the autonomous mobile device switches from a work mode (e.g., a cleaning mode of the autonomous mobile device) into a recharging mode, the method of the embodiments of the present disclosure may be started. That is, the at least two receivers disposed on the autonomous mobile device may receive the guidance signals transmitted by the transmitters on the charging base. In this embodiment, the guidance signals may include a first guidance signal, a second guidance signal, and a third guidance signal. The second guidance signal and the third guidance signal may be located at the left and right sides of the first guidance signal, respectively. The three guidance signals may be used to guide the autonomous mobile device to return to the charging base.

S102, determining output signals corresponding to the at least two receivers based on predetermined movement rules and the guidance signals received by the at least two receivers, wherein the predetermined movement rules include output signals corresponding to each receiver when the receiver receives different guidance signals.

In this step, when different receivers on the autonomous mobile device receive different guidance signals, the corresponding output signals may be different. When each receiver receives a guidance signal, each receiver may have a corresponding output signal. The output signal corresponding to the receiver may be used to indicate, under the condition that only this receiver receives the guidance signal, and when the receiver receives the guidance signal, the moving direction and moving angular velocity for the autonomous mobile device. The predetermined movement rules defines the output signal corresponding to each receiver when the receivers receive different guidance signals, i.e., the output values indicating the moving direction and the moving angular velocity.

Specifically, what kind of output signals correspond to the receivers when the receivers receive different guidance signals is defined by the predetermined movement rules. For example, when the receiver disposed at the front left side of the autonomous mobile device receives a first guidance signal, the corresponding output signal may instruct the autonomous mobile device to rotate counter-clock wise; when the receiver disposed at the front right side of the autonomous mobile device receives the first guidance signal, the corresponding output signal may instruct the autonomous mobile device to rotate clockwise, etc., thereby ensuring that the autonomous mobile device constantly adjusts the direction such that the autonomous mobile device approaches the charging base in a direction in which the autonomous mobile device straightly faces the charging base.

It should be noted that, in this step, it is only illustratively explained that the autonomous mobile device may determine the output signal corresponding to the receiver receiving a guidance signal based on the predetermined movement rules. In actual applications, the predetermined movement rules may be related to the number of receivers disposed on the autonomous mobile device, the location of each receiver, and the number of guidance signals transmitted by the charging base. The specific implementations in various application scenes will be explained in the following embodiments.

S103, performing a vector composition on the output signals corresponding to the receivers to obtain a vector sum, and controlling movement of the autonomous mobile device based on the vector sum.

Specifically, at a certain time instance and a certain location, it is possible that multiple receivers on the autonomous mobile device may receive the same or different guidance signals. For the multiple receivers that receive the guidance signals, based on predetermined movement rules, a vector composition may be performed on the output signals corresponding to the guidance signals received by the receivers to obtain a vector sum. The vector sum may indicate the moving direction and angular velocity for the autonomous mobile device at this time instance. When the autonomous mobile device moves to a next location at the next time instance, again output signals corresponding to the receivers may be obtained based on corresponding guidance signals received by various receivers and based on the predetermined movement rules. Again, the vector composition may be performed on the output signals to obtain a new vector sum at this location. The new vector sum may indicate the moving direction and angular velocity for the autonomous mobile device at this location. The similar processes may be repeated. Based on different poses of the autonomous mobile device at different locations, the receivers may receive the guidance signals and corresponding output signals may be obtained based on predetermined movement rules, and vector composition may be performed on the output signals corresponding to multiple receivers to obtain a vector sum, which may be used to instruct the autonomous mobile device to move based on predetermined movement rules, to return to the charging base. The output signals corresponding to the receivers may be used to indicate the moving direction and the moving angular velocity for the autonomous mobile device. In this embodiment, the output signal is a output value having a positive or negative sign. The positive or negative sign indicates a rotation direction of the movement (e.g., the positive sign may represent counter-clock wise, the negative sign may represent clockwise). The magnitude of the output value may be positively proportional to the moving angular velocity. When the autonomous mobile device moves toward the charging base, it is possible that multiple receivers may receive, at the same time, the same or different guidance signals. The direction and moving angular velocity indicated by the output corresponding to each receiver when each receiver receives the same or different guidance signals may be the same or may be different. As such, when the autonomous mobile device obtains the output signal corresponding to each receiver, the autonomous mobile device may perform a vector composition on the output signals corresponding to the multiple receivers to obtain a vector sum. The autonomous mobile device may be controlled based on the direction and the magnitude of the vector sum to approach the charging base.

It should be noted that, the vector composition refers to, a vector addition operation on output signals corresponding to multiple receivers when the multiple receivers receive the guidance signals at a same time instance. It should be noted that, the following situation may occur in actual applications, that is, at a certain time instance, only one receiver on the autonomous mobile device may receive the guidance signal. At this moment, the vector composition may be deemed as a vector composition between the output signal corresponding to the receiver and a zero vector. Based on the computation rules of vectors in mathematics, the vector sum is the output signal of the receiver itself. The vector addition operation is similar to the vector operation in mathematics, which is, when the moving directions indicated by the output signals corresponding to two receivers are the same, the moving direction of the vector sum may be the same as the moving direction indicated by the output signals. The value of the vector sum is the sum of the values of the output signals corresponding to the two receivers. If the moving directions indicated by the output signals corresponding to the two receivers are opposite, then the moving direction of the vector sum is the same as the direction of the output signal among the two output signals that has a relatively larger absolute value. The value of the vector sum may be a difference between the absolute values of the output signals corresponding to the two receivers.

It should be noted that, when performing the vector addition operation on output signals corresponding to more than two receivers, the vector addition operation may be performed on every two output signals to obtain a vector sum of the output signals corresponding to all of the receivers.

In this embodiment, through determining the output signals corresponding to each receiver based on the predetermined movement rules, the autonomous mobile device may be controlled to return to the charging base along an optimal route, such that the autonomous mobile device may dock with the charging base more efficiently and more accurately.

In some embodiments, the number of receivers on the autonomous mobile device may be, but not be limited to, 2, 3, 4, 5, 6, 7, or 8. Illustratively, to ensure that the autonomous mobile device can more accurately dock with the charging base, an even number of receivers, such as 2, 4, 6, 8 receivers, may be disposed on the autonomous mobile device, to ensure that the quantity of receivers on the left and right sides of the autonomous mobile device is equal, and such that these receivers may be disposed at left-right symmetric locations.

Illustratively, as shown in FIG. 2a-FIG. 2e, an autonomous mobile device may be provided with 2 receivers, 4 receivers, 6 receivers, or 8 receivers. Specifically:

As shown in FIG. 2a, the autonomous mobile device may be provided with a first receiver s1 and a second receiver s2. The first receiver s1 may be disposed at the front left side of the autonomous mobile device. The second receiver s2 may be disposed at the front right side of the autonomous mobile device. In some embodiments, the first receiver and the second receiver may be disposed at left-right symmetric locations.

As shown in FIG. 2b, the autonomous mobile device may be provided with the first receiver s1, the second receiver s2, a third receiver s3, and a fourth receiver s4. The first receiver s1 may be disposed at the front left side of the autonomous mobile device. The second receiver s2 may be disposed at the front right side of the autonomous mobile device. The third receiver s3 may be disposed at the front left side of the autonomous mobile device and may be located at a rear location with respect to the first receiver s1 along the circumference of the autonomous mobile device. The fourth receiver s4 may be disposed at the front right side of the autonomous mobile device and may be located at a rear location with respect to the second receiver s2 along the circumference of the autonomous mobile device. In some embodiments, the first receiver s1 and the second receiver s2 may be disposed at left-right symmetric locations, and/or the third receiver s3 and the fourth receiver s4 may be disposed at left-right symmetric locations.

As shown in FIG. 2c, the autonomous mobile device may be provided with the first receiver s1, the second receiver s2, the third receiver s3, the fourth receiver s4, a fifth receiver s5, and a sixth receiver s6. The first receiver s1 may be disposed at the front left side of the autonomous mobile device. The second receiver s2 may be disposed at the front right side of the autonomous mobile device. The third receiver s3 may be disposed at the front left side of the autonomous mobile device and may be located at a rear location with respect to the first receiver s1 along the circumference of the autonomous mobile device. The fourth receiver s4 may be disposed at the front right side of the autonomous mobile device and may be located at a rear location with respect to the second receiver s2 along the circumference of the autonomous mobile device. The fifth receiver s5 may be disposed at a rear left side of the autonomous mobile device and may be located at a rear location with respect to the third receiver s3 along the circumference of the autonomous mobile device. The sixth receiver s6 may be disposed at a rear right side of the autonomous mobile device and may be located at a rear location with respect to the fourth receiver s4 along the circumference of the autonomous mobile device. In some embodiments, the first receiver s1 and the second receiver s2 may be disposed at left-right symmetric locations, and/or the third receiver s3 and the fourth receiver s4 may be disposed at left-right symmetric locations, and/or the fifth receiver s5 and the sixth receiver s6 may be disposed at left-right symmetric locations.

It should be noted that, when 4 receivers are provided on the autonomous mobile device, they may be disposed at locations as shown in FIG. 2f. The first receiver s1 may be disposed at the front left side of the autonomous mobile device, the second receiver s2 may be disposed at the front right side of the autonomous mobile device. The fifth receiver s5 may be disposed at the rear left side of the autonomous mobile device. The sixth receiver s6 may be disposed at the rear right side of the autonomous mobile device. In some embodiments, the first receiver s1 and the second receiver s2 may be disposed at left-right symmetric locations, and/or the fifth receiver s5 and the sixth receiver s6 may be disposed at left-right symmetric locations. To avoid confusion in the description of the present disclosure, the numbering of the receivers corresponds to the disposition locations of the receivers. Therefore, in FIG. 2f, the two receivers disposed at the rear left side and the rear right side of the autonomous mobile device are named as the fifth receiver s5 and the sixth receiver s6, respectively. In predetermined movement rules, the output signals corresponding to the four receivers s1, s2, s5, and s6 receiving various guidance signals may be respectively the same as the output signals corresponding to the four receivers s1, s2, s5, and s6 receiving the guidance signals in the embodiments shown in FIG. 2c and FIG. 2d.

As shown in FIG. 2d, FIG. 2e, the autonomous mobile device may be provided with the first receiver s1, the second receiver s2, the third receiver s3, the fourth receiver s4, the fifth receiver s5, the sixth receiver s6, a seventh receiver s7, and an eighth receiver s8. The first receiver s1 may be disposed at the front left side of the autonomous mobile device. The second receiver s2 may be disposed at the front right side of the autonomous mobile device. The third receiver s3 may be disposed at the front left side of the autonomous mobile device and may be located at a rear location with respect to the first receiver s1 along the circumference of the autonomous mobile device. The fourth receiver s4 may be disposed at the front right side of the autonomous mobile device and may be located at a rear location with respect to the second receiver s2 along the circumference of the autonomous mobile device. The fifth receiver s5 may be disposed at a rear left side of the autonomous mobile device and may be located at a rear location with respect to the third receiver s3 along the circumference of the autonomous mobile device. The sixth receiver s6 may be disposed at a rear right side of the autonomous mobile device and may be located at a rear location with respect to the fourth receiver s4 along the circumference of the autonomous mobile device. The seventh receiver s7 may be disposed at a rear left side of the autonomous mobile device and may be located at a rear location with respect to the fifth receiver s5 along the circumference of the autonomous mobile device. The eighth receiver s8 may be disposed at a rear right side of the autonomous mobile device and may be located at a rear location with respect to the sixth receiver s6 along the circumference of the autonomous mobile device. In some embodiments, the first receiver s1 and the second receiver s2 may be disposed at left-right symmetric locations, and/or the third receiver s3 and the fourth receiver s4 may be disposed at left-right symmetric locations, the fifth receiver s5 and the sixth receiver s6 may be disposed at left-right symmetric locations, and/or the seventh receiver s7 and the eighth receiver s8 may be disposed at left-right symmetric locations.

It should be noted that, in the embodiments of the present disclosure, the left side or the right side of the autonomous mobile device, unless specifically noted otherwise, refer to, in a top view of the autonomous mobile device, when the forward moving direction of the autonomous mobile device is treated as the front side, the left side and the right side of the autonomous mobile device. Illustratively, the arrow directions shown in FIG. 2a-FIG. 2d, and FIG. 2f on the autonomous mobile device indicate the forward moving direction of the autonomous mobile device. The left side and the right side of the autonomous mobile device are the left side and the right side when the forward moving direction of the autonomous mobile device is the front direction, as shown in the figures.

It should be noted that, the above examples only list four possible configurations for the receivers disposed on the autonomous mobile device. Actual application scenes may not be limited to the four configurations. For example, the autonomous mobile device may be provided with the first receiver s1, the second receiver s2, the fifth receiver s5, and the sixth receiver s6. The first receiver s1 may be disposed at the front left side of the autonomous mobile device, the second receiver s2 may be disposed at the front right side of the autonomous mobile device, the fifth receiver s5 may be disposed at the rear left side of the autonomous mobile device, and the sixth receiver s6 may be disposed at the rear right side of the autonomous mobile device. Illustratively, the first receiver s1 and the second receiver s2 may be disposed at left-right symmetric locations, and/or the fifth receiver s5 and the sixth receiver s6 may be disposed at left-right symmetric locations. Here, examples are not provided any more.

In some embodiments, the number of guidance signals transmitted by the transmitters on the charging base can is not limited to being the three types (first guidance signal, second guidance signal, and third guidance signal) in the embodiment shown in FIG. 1, but may also be 1 type. Alternatively, in the embodiment that includes three guidance signals as shown in the embodiment of FIG. 1, the charging base may be provided with at least two transmitters (namely, a fourth transmitter and a fifth transmitter). A fourth guidance signal and a fifth guidance signal transmitted by the fourth transmitter and the fifth transmitter respectively may be respectively located at the left side and the right side of the whole set of three guidance signals, namely the first guidance signal, the second guidance signal, and the third guidance signal. In some embodiments, to ensure that the autonomous mobile device can more accurately dock with the charging base to perform battery charging, when the charging base transmits a directional guidance signal, the coverage scope (i.e., the signal transmitting direction) of the guidance signal may be set to cover a central zone in front of the charging base. When the charging base transmits multiple types, such as 3 or 5 types, of directional guidance signals, a middle directional guidance signal (i.e., the above first guidance signal) may be controlled to cover the central zone in front of the charging base, and other 2 or 4 types of directional guidance signals (excluding the first guidance signal) may cover the left side zone and the right side zone of the central zone in a left-right symmetric manner with respect to an axis of symmetry that is the first guidance signal.

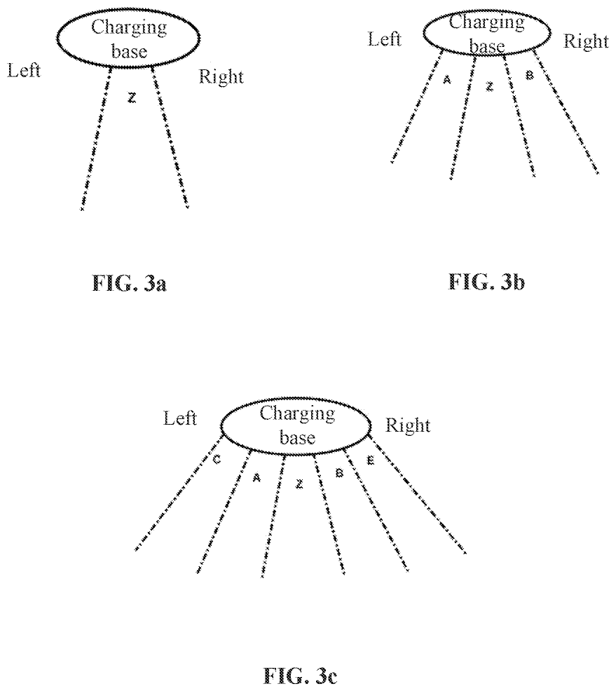

Illustratively, as shown in FIG. 3a-FIG. 3c, the configurations of the transmitter(s) of the charging base transmitting one type of guidance signal, 3 types of guidance signals, and 5 types of guidance signals are respectively shown. More specifically:

As shown in FIG. 3a, the charging base may be provided with one transmitter, referred to as a first transmitter, configured to transmit a directional guidance signal, referred to as a first guidance signal. The first guidance signal is also referred to as a Z signal. The coverage scope, i.e., the signal transmitting direction of the first guidance signal, is also referred to as a first direction, which is shown as the scope between the dot-dashed lines in FIG. 3a, i.e., the central zone in front of the charging base.

As shown in FIG. 3b, the charging base may be provided with three transmitters, i.e., a first transmitter, a second transmitter, and a third transmitter, configured to transmit a first guidance signal, a second guidance signal, and a third guidance signal, respectively. The first guidance signal may also be referred to as a Z signal, the coverage scope of which may be the central zone in front of the charging base. The second guidance signal may also be referred to as an A signal, the coverage zone of which may be located at the left side of the coverage zone of the Z signal. The third guidance signal may also be referred to as a B signal, the coverage zone of which may be located at the right side of the coverage zone of the Z signal. As shown in the figure, illustratively, the coverage zones of the A signal and B signal may be left-right symmetric.

As shown in FIG. 3c, charging base may be provided with five transmitters, a first transmitter, a second transmitter, a third transmitter, a fourth transmitter, and a fifth transmitter, configured to transmit a first guidance signal, a second guidance signal, a third guidance signal, a fourth guidance signal, and a fifth guidance signal, respectively. The second guidance signal may be located at the left side of the first guidance signal. The third guidance signal may be located at the right side of the first guidance signal. The fourth guidance signal may be located at the left side of the second guidance signal, i.e., one of two sides of the second guidance signal that is farther away from the first guidance signal. The fifth guidance signal may be located at the right side of the third guidance signal, i.e., one of two sides of the third guidance signal that is farther away from the first guidance signal. The first guidance signal may also be referred to as a Z signal. The coverage zone of the Z signal may be the central zone in front of the charging base. The second guidance signal may also be referred to as an A signal, the third guidance signal may also be referred to as a B signal. The coverage zone of the A signal and the coverage zone of the B signal may be symmetrically located at the left side and the right side of the coverage zone of the Z signal. The fourth guidance signal may also be referred to as a C signal. The coverage zone of the C signal may be located at the left side of the coverage zone of the A signal. The fifth guidance signal may also be referred to as an E signal. The coverage zone of the E signal may be located at the right side of the coverage zone of the B signal. The coverage zone of the C signal and the coverage zone of the E signal may be left-right symmetric, as shown in FIG. 3c.

It should be noted that, for the convenience of description, in the embodiments of the present disclosure, the setting of the guidance signal is used to replace the setting of the transmitter that transmits the guidance signal. For example, “the second transmitter that transmits the second guidance signal is disposed at the left side of the first transmitter that transmits the first guidance signal, and the second guidance signal is located at the left side of the first guidance signal,” may be simply described as “the second guidance signal is located at the left side of the first guidance signal.” In addition, when describing the left side or right side of the guidance signal, the left side or right side mentioned refers to the left side or right side of the charging base that one can see when facing charging base. Illustratively, for the charging base shown in FIG. 3a-FIG. 3c, the left side or right side of the guidance signal refers to the left side or right side of the charging base when one faces the charging base, as shown by the “left,” “right” in the figures.

It should be noted that, the above examples only list three possible configurations for the guidance signals transmitted by the transmitter(s) provided on the charging base. Actual application scenes may not be limited to the three configurations. Here, examples are not provided any more.

It should be noted that the predetermined movement rules based on which the autonomous mobile device approaches the charging base may be related to the number of receivers provided on the autonomous mobile device, the location of each receiver, and the number of guidance signals transmitted by the charging base. Next, this will be described in detail in specific implementations in various application scenes.

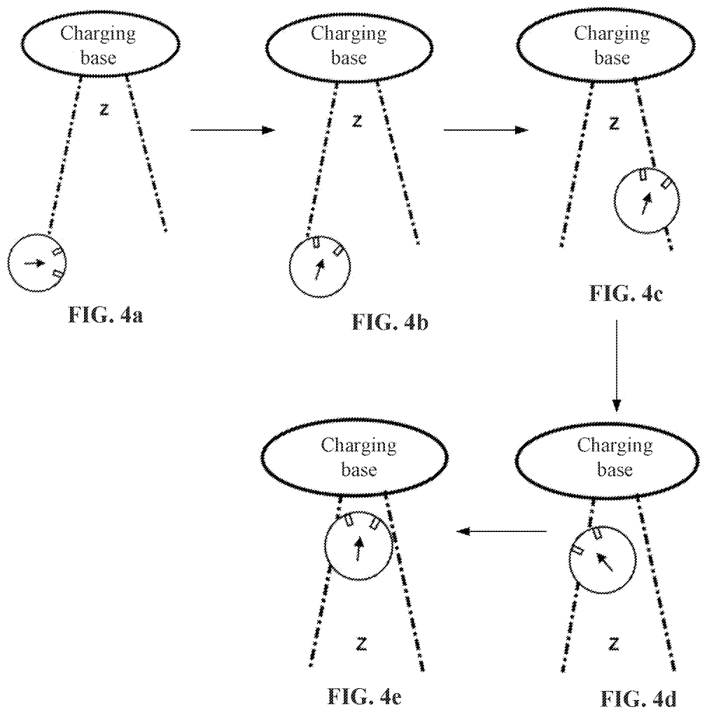

FIGS. 4a-4e show a first application scene of the recharging method for the autonomous mobile device, according to an illustrative embodiment of the present disclosure. This application scene is described using an example, in which the front portion of the autonomous mobile device is provided with a first receiver s1 and a second receiver s2 that are disposed at left-right symmetric locations, and a first guidance signal is the guidance signal transmitted by a first transmitter disposed on the charging base.

In this embodiment, the autonomous mobile device provided with two receivers is shown in FIG. 2a, the coverage scope of the guidance signal transmitted by the charging base is shown in FIG. 3a.

Specifically, the transmitter on the charging base transmits the guidance signal, which may be referred to as the Z signal. The coverage zone of the Z signal may be a central zone in a first direction (i.e., the transmitting direction of the Z signal) of the charging base.

In this embodiment, the first transmitter on the charging base transmits the first guidance signal, i.e., the Z signal, which is shown in FIG. 3a and described in the above embodiment. The autonomous mobile device may be provided with two receivers s1 and s2, which are shown in FIG. 2a and described in the above embodiment. The descriptions are not repeated. The predetermined movement rules may be: when the first receiver s1 receives the first guidance signal (i.e., the Z signal), the moving direction indicated by the output signal corresponding to the first receiver s1 may be the counter-clockwise direction, the moving angular velocity may be a first angular velocity; when the second receiver s2 receives the first guidance signal, the moving direction indicated by the output signal corresponding to the second receiver may be the clockwise direction, and the moving angular velocity may be a second angular velocity.

It should be noted that, in some embodiments, the first receiver s1 and the second receiver s2 may be located at the head (i.e., front) portion of the autonomous mobile device and may be at left-right symmetric locations. The coverage zone of the Z signal may be a center zone in front of the charging base. Therefore, to ensure that the autonomous mobile device can more accurately dock with the charging base when moving toward the charging base based on the predetermined movement rules, the above first angular velocity and the second angular velocity may be the same.

In one possible implementation of this embodiment, the predetermined movement rules may be those listed in Table 1. In Table 1, output values with positive or negative sign are used to indicate the output signals corresponding to the receiver. The positive sign “+” indicates that the moving direction is the counter-clockwise direction. The negative sign “−” indicates that the moving direction is the clockwise direction. The output value may be proportional to the angular velocity, and is used to indicate the magnitude of the angular velocity. For example, the angular velocity may be: ω=k·N, where N represents an output value corresponding to the receiver receiving the guidance signal, k is a constant number (e.g., k=0.1°/s). As shown in Table 1, when the receiver s1 receives the Z signal, the corresponding output signal is +100, and the corresponding angular velocity is ω=+100k, i.e., ω=+10°/s. The positive sign “+” indicates that the moving direction is the counter-clockwise direction. When the receiver s2 receives the Z signal, the corresponding output signal is −100, and the corresponding moving angular velocity is ω=−10°/s. The negative sign “−” indicates that the moving direction is the clockwise direction. For the convenience of description, no unit is added to the output value in the present disclosure. It can be seen from the above example, the output value in the present disclosure may be equivalent to the moving angular velocity.

TABLE 1

| | Receiver s1 | Receiver s2 |
|---|---|---|
| First guidance signal (Z signal) | +100 | −100 |

Illustratively, the processes of the autonomous mobile device moving based on the predetermined movement rules of Table 1 are shown in FIGS. 4a-4e. Assuming that the autonomous mobile device moves to a location shown in FIG. 4a, at this moment, the first receiver s1 located at the front left side may receive the first guidance signal, i.e., Z signal, located at the central zone. The second receiver s2 located at the front right side may be blocked by the autonomous mobile device and may not receive the first guidance signal, i.e., Z signal. According to Table 1, the autonomous mobile device moves forwardly to approach the charging base while rotating counter-clockwise at a certain moving angular velocity (the angular velocity of rotation may be proportional to the output value of the receiver s1, which may be 100k). When the autonomous mobile device moves to the pose (including location and facing direction) indicated in FIG. 4b, at this moment, the two receivers s1 and s2 may both receive the Z signal. According to Table 1, the output signal corresponding to the receiver s1 indicates counter-clockwise rotation, the output signal corresponding to the receiver s2 indicates clockwise rotation, and the two output signals indicate the same moving angular velocity, both being 100. A vector composition may be performed on the two output signals. The two output signals have the same magnitude and opposite directions, and therefore, may cancel one another. Ultimately, the autonomous mobile device moves straightly toward the charging base along the current forward moving direction (the direction indicated by the arrow). When the autonomous mobile device moves to the pose indicated in FIG. 4c, at this moment, only the receiver s1 receives the Z signal. The autonomous mobile device moves forwardly to approach the charging base while rotating counter-clockwise at a certain moving angular velocity (100k). During the process of the autonomous mobile device rotating or moving straightly, it is possible that a certain receiver may be located out of the coverage scope of the Z signal, for example, at the pose of the autonomous mobile device shown in FIG. 4d. According to Table 1, the receiver s1 may not receive the Z signal, and the output signal corresponding to the receiver s2 indicates a clockwise rotation. Therefore, the autonomous mobile device moves forwardly to approach the charging base while rotating clockwise at a certain angular velocity, until the two receivers of the autonomous mobile device can both receive the Z signal, as shown in FIG. 4e, and then the autonomous mobile device moves straightly to approach the charging base. Finally, the autonomous mobile device may be controlled based on the vector sum obtained from performing a vector composition on the output signals corresponding to the two receivers, to approach a center of the charging base. Eventually, the charging points of the autonomous mobile device may contact the charging plates on the charging base, to perform battery charging.

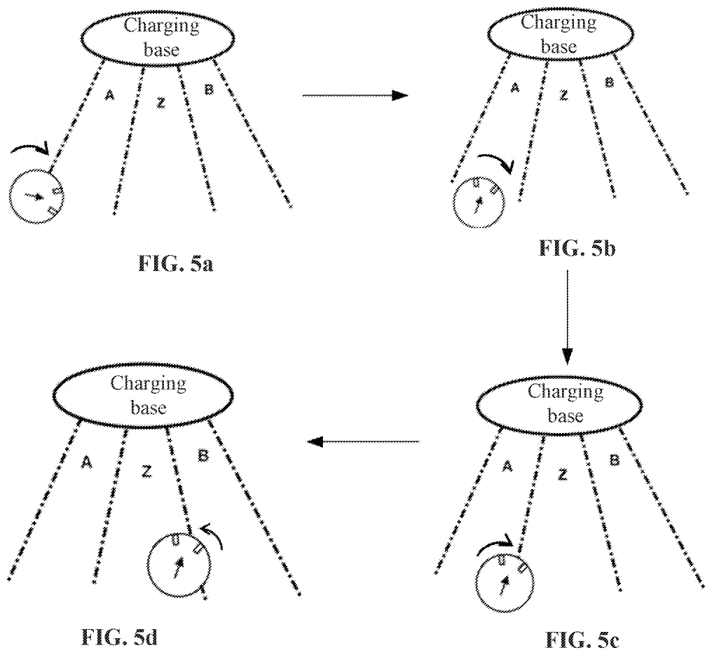

FIGS. 5a-5d show a second application scene of the recharging method for the autonomous mobile device according to an illustrative embodiment of the present disclosure. In this embodiment, the charging base may be provided with three transmitters configured to transmit the first guidance signal (i.e., Z signal), a second guidance signal (i.e., A signal), and a third guidance signal (i.e., B signal), respectively, as shown in FIG. 3b and as described in above embodiment, which are not repeated. The autonomous mobile device may be provided with two receivers s1, s2, the configuration of which can refer to FIG. 2a and the descriptions of the above embodiment, which are not repeated. Next, the embodiment shown in FIGS. 5a-5d will be described in detail.

In this embodiment, the predetermined movement rules may be defined as: the output signal corresponding to the receiver s1 receiving the Z signal may indicate a moving direction that is a counter-clockwise direction, and a moving angular velocity that is a first angular velocity; the output signal corresponding to the receiver s2 receiving the Z signal may indicate a moving direction that is a clockwise direction, and a moving angular velocity that is a second angular velocity; the output signal corresponding to the receiver s1 receiving the A signal may indicate a moving direction that is a clockwise direction, and a moving angular velocity that is a third angular velocity; the output signal corresponding to the receiver s2 receiving the A signal may indicate a moving direction that is a clockwise direction, and a moving angular velocity that is a fourth angular velocity; the output signal corresponding to the receiver s1 receiving the B signal may indicate a moving direction that is a counter-clockwise direction, and a moving angular velocity that is a fifth angular velocity; the output signal corresponding to the receiver s2 receiving the B signal may indicate a moving direction that is a counter-clockwise direction, and a moving angular velocity that is a sixth angular velocity.

Illustratively, if the first receiver s1 and the second receiver s2 are located at the front portion of the autonomous mobile device and the locations are left-right symmetric, and the A signal and the B signal are adjacent the Z signal, and are left-right symmetric with respect to the Z signal, then the first angular velocity and the second angular velocity may be the same, the third angular velocity and the sixth angular velocity may be the same, the fourth angular velocity and the fifth angular velocity may be the same. Because the coverage zones of the A signal and the B signal are located at the left side and right side in front of the charging base, the fourth angular velocity and the fifth angular velocity may be set to be greater than the third angular velocity and the sixth angular velocity, such that the autonomous mobile device approaches the charging base in a first direction; and/or the third angular velocity and the sixth angular velocity may be set to be greater than the first angular velocity and the second angular velocity, such that when the autonomous mobile device is at a location further away from the charging base in the first direction, the moving angular velocity is greater, and the movement is quicker.

In a possible implementation of this embodiment, the predetermined movement rules may be set as those shown in Table 2. The output values having the positive or negative sign in Table 2 indicate the output signals corresponding to the receivers. The positive or negative sign in the output signals and the meaning of the output values are the same as those in the above embodiment, which are not repeated.

TABLE 2

| | Receiver s1 | Receiver s2 |
|---|---|---|
| First guidance signal (Z signal) | +100 | −100 |
| Second guidance signal (A signal) | −120 | −150 |
| Third guidance signal (B signal) | +150 | +120 |

Illustratively, the processes of the autonomous mobile device moving according to the predetermined movement rules shown in Table 2 are shown in FIGS. 5a-5d. Assuming that the autonomous mobile device moves to the location shown in FIG. 5a, at this moment, the receiver s1 disposed on the left side of the autonomous mobile device receives the second guidance signal (i.e., the A signal) on the left side, and the receiver s2 is blocked by the autonomous mobile device and may not receive the A signal, therefore, the output signal of the receiver s2 is 0. According to Table 2, the vector sum is −120 (i.e., the vector sum of the output signals of the receivers s1 and s2 is −120+0=−120), and then the autonomous mobile device moves forwardly while rotating in the clockwise direction as indicated by the arrow in FIG. 5a and at a moving angular velocity of 120k, such that the autonomous mobile device yaws in a direction that is parallel with a circumferential direction of a concentric circle that uses the charging base as a center, and moves toward the coverage zone of the Z signal.

If the autonomous mobile device moves to the location shown in FIG. 5b, at this moment, the two receivers s1 and s2 both receive the A signal at the left side. Then according to Table 2, both output signals of the two receivers instruct the autonomous mobile device to move in a clockwise direction. Performing a vector composition on the two output signals corresponding to the two receivers of the autonomous mobile device obtains a vector sum of −270 (i.e., the vector sum of the output signals of the receivers s1 and s2 is (−120−150)=−270). Then, the autonomous mobile device may move forwardly while rotating in the clockwise direction as indicated by the arrow in FIG. 5b and at a moving angular velocity of 270k, such that the autonomous mobile device yaws in a direction that is parallel with a circumferential direction of a concentric circle that uses the charging base as a center, and moves toward the coverage zone of the Z signal. When the autonomous mobile device moves into the coverage scope of the A signal, because the coverage scope of the A signal is away from the central location, and is relatively far away from the central location of the charging base, the output signals of the two receivers instruct the autonomous mobile device to move in a direction moving away from the charging base and facing the coverage zone of the first guidance signal (i.e., the Z signal) located at the central location, such that the autonomous mobile device can quickly move to the central zone of the charging base (i.e., the coverage zone of the Z signal). The vector sum of 270k under this condition is far greater than the vector sum of 120k for the situation shown in FIG. 2a, in which a single receiver s1 receives the A signal. In other words, at the pose (including location and facing direction) of the autonomous mobile device in FIG. 2b, as compared to the pose shown in FIG. 2a, if there is a need to move into the coverage scope of the Z signal, the autonomous mobile device needs to turn a larger angle. That is, in a same time period, a greater angular velocity is needed such that the autonomous mobile device can quickly turn to a direction parallel with the circumferential direction of the concentric circle that uses the charging base as the center, and face the Z signal, and such that the autonomous mobile device can move toward the coverage scope of the Z signal in subsequent movements, and then approach the charging base in a manner shown in the embodiment of FIGS. 4a-4e.

If the autonomous mobile device moves to the location shown in FIG. 5c, at this moment, the two receivers s1 and s2 receive the A signal and the Z signal, respectively. Then, according to the movement rules of Table 2, the output signal corresponding to the receiver s1 is −120, and the output signal corresponding to the receiver s2 is −100. Both of the two output signals instruct the autonomous mobile device to turn clockwise, and the autonomous mobile device moves forwardly while rotating at a moving angular velocity that is indicated by the vector sum of the output values corresponding to the two receivers (the moving angular velocity is proportional to 220, such as 220k, which is greater than the output signal of −120 corresponding to only the receiver s1 receiving the A signal in FIG. 2a). Then the autonomous mobile device moves forwardly while rotating in the clockwise direction as indicated by the arrow shown in FIG. 5c and at a moving angular velocity of 220k, such that the autonomous mobile device moves toward the coverage zone of the Z signal, until both of the two receivers s1 and s2 enter the coverage zone of the Z signal. Then, the autonomous mobile device may approach the charging base in a manner according to the embodiment shown in FIGS. 4a-4e.

If the autonomous mobile device moves to the location shown in FIG. 5d, at this moment, the two receivers s1, s2 receive the Z signal, the B signal, respectively. According to Table 2, the output signal corresponding to the receiver s1 may be +100, the output value corresponding to the receiver s2 may be +120. Both output signals instruct the autonomous mobile device to turn counter-clockwise. The autonomous mobile device moves forwardly while turning at a moving angular velocity indicated by the vector sum of the output signals corresponding to the two receivers s1, s2 (the moving angular velocity may be proportional to 220, such as 220k, hence, the situations shown in FIG. 2d and FIG. 2c are left-right symmetric, i.e., the moving angular velocities have the same magnitude, and the rotating directions are opposite). Then, the autonomous mobile device may move forwardly while rotating in the counter-clockwise direction as indicated by the arrow shown in FIG. 5d, and at a moving angular velocity of 220k, such that the autonomous mobile device moves toward the coverage zone of the Z signal, until both of the two receivers enter the coverage zone of the Z signal. Then the autonomous mobile device may approach the charging base in a manner according to the embodiment shown in FIGS. 4a-4e, such that the charging points on the autonomous mobile device contact the charging plates on the charging base, to realize battery charging.

It should be noted that in FIGS. 5a-5d, because the A signal and the B signal are located at the two sides of the Z signal located at the center, and the locations of the A signal and the B signal are left-right symmetric with respect to the Z signal, and because the receivers s1 and s2 on the autonomous mobile device are also disposed at two sides of the autonomous mobile device at left-right symmetric locations, for the situations shown in FIGS. 5c-5d, the movement behaviors of the autonomous mobile device in both sub-figures under the control based on the vector sums obtained from performing a vector composition on the output signals corresponding to the receivers s1, s2, are symmetric. Thus, in the subsequent symmetric situations (e.g., the situation of two receivers s1, s2 both receiving the B signal being symmetric with the situation of two receivers s1, s2 both receiving the A signal shown in FIG. 5b; the situation of two receivers s1, s2 receiving the Z signal and the B signal respectively being symmetric with the situation of two receivers s1, s2 receiving the A signal and the Z signal respectively), which are not repeated.

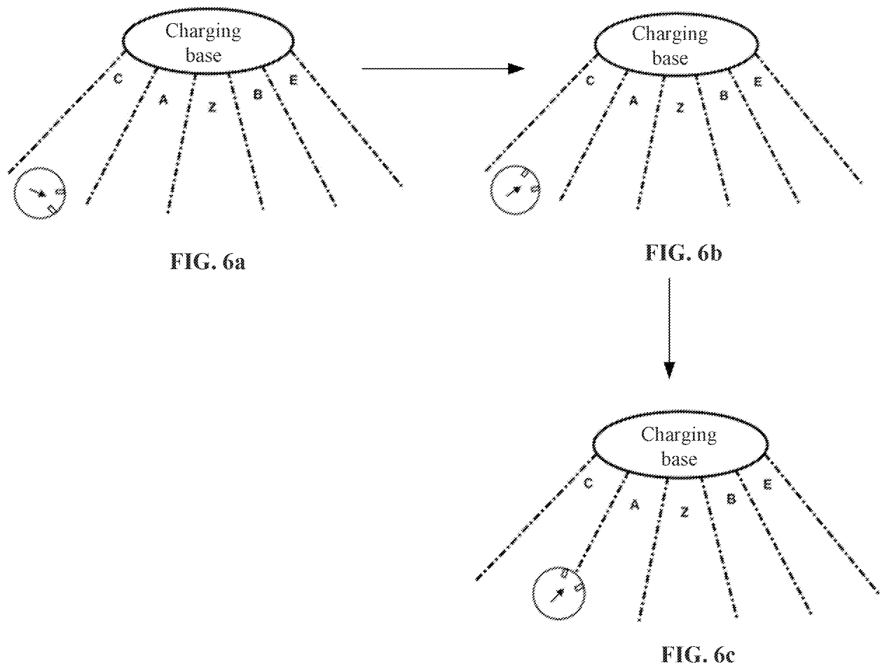

FIGS. 6a-6c show a third application scene of the recharging method for the autonomous mobile device according to an illustrative embodiment of the present disclosure. This embodiment is based on the embodiment shown in FIGS. 5a-5d, and two transmitters are added on the charging base, which are configured to transmit a fourth guidance signal (i.e., the C signal) and a fifth guidance signal (i.e., the E signal), respectively. The fourth guidance signal (i.e., the C signal) may be located at the left side of the second guidance signal (i.e., the A signal). The fifth guidance signal (i.e., the E signal) may be located at the right side of the third guidance signal (i.e., the B signal). In this embodiment, the coverage effects of the five guidance signals transmitted by the charging base are shown in FIG. 3c, which are described in the above embodiment, and hence are not repeated here. Two receivers s1 and s2 may be provided on the autonomous mobile device, the configurations of which are shown in FIG. 2a, and are described in the above embodiment, which are not repeated.

In the situation of this embodiment, in which the five guidance signals, i.e., the Z signal, the A signal, the B signal, the C signal, and the E signal are transmitted from the charging base, and two receivers s1, s2 are disposed at the front portion of the autonomous mobile device, the predetermined movement rules are shown in Table 3.1. The moving angular velocity indicated by the output signal corresponding to each receiver receiving the guidance signal may be: if the first receiver s1 receives the first guidance signal (i.e., the Z signal), the output signal corresponding to the first receiver s1 may indicate a moving direction that is a counter-clockwise direction, and a moving angular velocity that is a first angular velocity; if the second receiver s2 receives the first guidance signal (i.e., the Z signal), the output signal corresponding to the second receiver s2 may indicate a moving direction that is the clockwise direction and a moving angular velocity that is a second angular velocity; if the first receiver s1 receives the second guidance signal (i.e., the A signal), then the output signal corresponding to the first receiver s1 may indicate a moving direction that is a clockwise direction and a moving angular velocity that is a third angular velocity; if the second receivers s2 receives the second guidance signal (i.e., the A signal), then the output signal corresponding to the second receiver s2 may indicate a moving direction that is the clockwise direction and a moving angular velocity that is a fourth angular velocity; if the first receiver s1 receives the third guidance signal (i.e., the B signal), then the output signal corresponding to the first receiver s1 may indicate a moving direction that is the counter-clockwise direction and a moving angular velocity that is a fifth angular velocity; if the second receiver s2 receives the third guidance signal (i.e., the B signal), then the output signal corresponding to the second receiver s2 may indicate a moving direction that is the counter-clockwise direction and a moving angular velocity that is a sixth angular velocity; if the first receiver s1 receives the fourth guidance signal (i.e., the C signal), then the output signal corresponding to the first receiver s1 may indicate a moving direction that is the clockwise direction and a moving angular velocity that is a seventh angular velocity; if the second receiver s2 receives the fourth guidance signal (i.e., the C signal), then the output signal corresponding to the second receiver s2 may indicate a moving direction that is the clockwise direction and a moving angular velocity that is an eighth angular velocity; if the first receiver s1 receives the fifth guidance signal (i.e., the E signal), then the output signal corresponding to the first receiver s1 may indicate a moving direction that is the counter-clockwise direction and a moving angular velocity that is a ninth angular velocity; if the second receiver s2 receives the fifth guidance signal (i.e., the E signal), then the output signal corresponding to the second receiver s2 may indicate a moving direction that is the counter-clockwise direction and a moving angular velocity that is a tenth angular velocity.

TABLE 3.1

| | s1 | s2 |
|---|---|---|
| First guidance signal | First angular | Second angular |
| (Z signal) | velocity | velocity |
| Second guidance signal | Third angular | Fourth angular |
| (A signal) | velocity | velocity |
| Third guidance signal | Fifth angular | Sixth angular |
| (B signal) | velocity | velocity |
| Fourth guidance signal | Seventh angular | Eighth angular |
| (C signal) | velocity | velocity |
| Fifth guidance signal | Ninth angular | Tenth angular |
| (E signal) | velocity | velocity |

It should be noted that, in this embodiment, the first receiver s1 and the second receiver s2 are disposed at the front left side and the front right side of the autonomous mobile device, and the locations of the first receiver s1 and the second receiver s2 are left-right symmetric. In the figure, the scope between the dot-dashed lines on two sides of the Z signal is the coverage zone of the center guidance signal (i.e., the first guidance signal), i.e., Z signal. The A signal and the B signal may be adjacent to the Z signal, and may be left-right symmetric. The C signal and the E signal may be left-right symmetric. Therefore, to further ensure that the autonomous mobile device can more accurately dock with the charging base when approaching the charging base according to the predetermined movement rules, the above-described first angular velocity and the second angular velocity may be the same. The third angular velocity and the sixth angular velocity may be the same. The fourth angular velocity and the fifth angular velocity may be the same. Because the C signal is an extension of the A signal toward the left side of the charging base, the E signal is an extension of the B signal toward the right side of the charging base, illustratively, the third angular velocity and the seventh angular velocity may be the same, the fourth angular velocity and the eighth angular velocity may be the same, the fifth angular velocity and the ninth angular velocity may be the same, the sixth angular velocity and the tenth angular velocity may be the same. In some embodiments, the seventh angular velocity may be set to be greater than the third angular velocity, the eighth angular velocity may be set to be greater than the fourth angular velocity, the ninth angular velocity may be set to be greater than the fifth angular velocity, the tenth angular velocity may be set to be greater than the sixth angular velocity, such that a moving angular velocity corresponding to any receiver of the autonomous mobile device located within the coverage scope of the C signal or the E signal is greater than the moving angular velocity of such receiver in the coverage scope of the A signal or the B signal.

In this embodiment, when the autonomous mobile device receives the A signal, the B signal, the C signal, or the E signal, according to the predetermined movement rules, the autonomous mobile device moves in a direction parallel with a circumferential direction of a concentric circle that uses the charging base as a center, toward the coverage zone of the Z signal. When receiving the Z signal, the autonomous mobile device moves from the center zone right in front of the charging base along the coverage scope of the Z signal of the charging base to approach the charging base.

In one possible implementation of this embodiment, the predetermined movement rules may be set as shown in Table 3.2. The positive or negative sign in the output signals shown in the table and the meaning of the output values are the same as the above embodiment, which are not repeated.

TABLE 3.2

| | Receiver s1 | Receiver s2 |
|---|---|---|
| First guidance signal (Z signal) | +100 | −100 |
| Second guidance signal (A signal) | −120 | −150 |
| Third guidance signal (B signal) | +150 | +120 |
| Fourth guidance signal (C signal) | −120 | −150 |
| Fifth guidance signal (E signal) | +150 | +120 |

Illustratively, the processes of the autonomous mobile device moving according to the predetermined movement rules shown in Table 3.2 are shown in FIGS. 6a-6c. Because the output values corresponding to the two receivers s1, s2 receiving the C signal are the same as the output values of the two receivers receiving the A signal on the same side, the movement behavior of the autonomous mobile device when the autonomous mobile device is at the pose (including location and facing direction) shown in FIG. 6a, is similar to the movement behavior of the autonomous mobile device when the autonomous mobile device is at the pose shown in FIG. 5a. The movement behavior of the autonomous mobile device when the autonomous mobile device is at the pose (including location and facing direction) shown in FIG. 6b, is similar to the movement behavior of the autonomous mobile device when the autonomous mobile device is at the pose shown in FIG. 5b.

If the autonomous mobile device is at the pose shown in FIG. 6c, at this moment, the two receivers s1, s2 may receive the C signal and the A signal, respectively. Then according to Table 3.2, the output value corresponding to the receiver s1 is −120, the output value corresponding to the receiver s2 is −150. Both of the two output signals instruct the autonomous mobile device to rotate clockwise, and the vector sum of the output values corresponding to the two receivers s1, s2 of the autonomous mobile device is (−120−150)=−270. The moving angular velocity may be proportional to 270, such as 270k. The autonomous mobile device may move forwardly while rotating in the clockwise direction at a moving angular velocity of 270k, such that the autonomous mobile device yaws in a direction parallel with the circumferential direction of a concentric circle that uses the charging base as a center, and moves toward the coverage zone of the Z signal, until the two receivers s1, s2 both enter the coverage zone of the Z signal. The autonomous mobile device then approaches the charging base in a manner according the embodiment shown in FIGS. 4a-4e. When the third angular velocity and the seventh angular velocity are the same, the fourth angular velocity and the eighth angular velocity are the same, the fifth angular velocity and the ninth angular velocity are the same, and the sixth angular velocity and the tenth angular velocity are the same, the movement behavior of the autonomous mobile device as shown in FIG. 6c is similar to the movement behavior of the autonomous mobile device as shown in FIG. 6b and FIG. 5b.

It should be noted that the situation in which both of the two receivers s1, s2 of the autonomous mobile device receive the A signal is similar to the situation when the autonomous mobile device is at the pose shown in FIG. 5b, which is not repeated.

It should be noted that the situation in which both of the two receivers s1, s2 of the autonomous mobile device receive the A signal and the Z signal is similar to the situation when the autonomous mobile device is at the pose shown in FIG. 5c, which is not repeated.

It should be noted that, the situation in which both of the two receivers s1, s2 of the autonomous mobile device receive the Z signal is similar to the situation when the autonomous mobile device is at the pose shown in FIG. 4b, which is not repeated.

In this embodiment, when the autonomous mobile device is located in the coverage zones of the A signal, the B signal, the C signal, and the E signal, which are located at non-center zones, based on the instructions indicated by the output signals corresponding to the receivers s1, s2, the autonomous mobile device moves toward the coverage zone of the Z signal in a direction that is not approaching the charging base, until both of the two receivers s1, s2 enter the coverage zone of the Z signal. Then the autonomous mobile device may approach the charging base according to the embodiment shown in FIG. 4b, and to perform battery charging on the charging base.

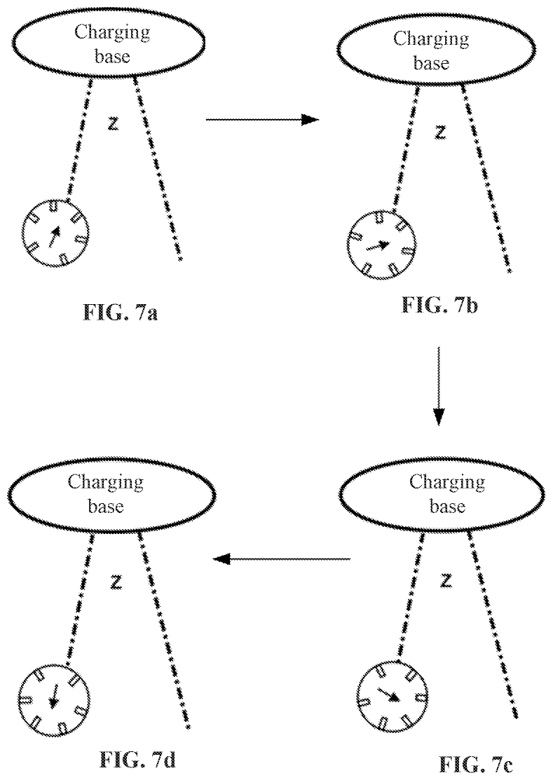

FIGS. 7a-7d show a fourth application scene of the recharging method for the autonomous mobile device according to an illustrative embodiment of the present disclosure. This embodiment is based on the embodiment shown in FIGS. 4a-4e. In the following description, as an example, the autonomous mobile device may be provided with four additional receivers, and hence may have six receivers configured to receive the first guidance signal (i.e., the Z signal) transmitted by the first transmitter of the charging base.

In this embodiment, the configuration of the six receivers on the autonomous mobile device is shown in FIG. 2c. The coverage effect of the first guidance signal (i.e., the Z signal) transmitted by the charging base is shown in FIG. 3a.

In one possible implementation of this embodiment, in addition to the predetermined movement rules described in the embodiment of FIGS. 4a-4e, the predetermined movement rules may also include: when the third receiver s3, the fifth receiver s5, and the first receiver s1 receive the first guidance signal (i.e., the Z signal), the moving directions indicated by the corresponding output signals are the counter-clockwise direction. When the fourth receiver s4, the sixth receiver s6, and the second receiver s2 receive the first guidance signal (i.e., the Z signal), the moving directions indicated by the corresponding output signals are the clockwise direction.

It should be noted that, the third receiver s3, the fifth receiver s5, and the first receiver s1 are disposed on the left side of the autonomous mobile device, the fourth receiver s4, the sixth receiver s6, and the second receiver s2 are disposed on the right side of the autonomous mobile device. Illustratively, the first receiver s1 and the second receiver s2 are disposed at the left and right sides of the front portion of the autonomous mobile device in a left-right symmetric manner. The third receiver s3 and the fourth receiver s4 are disposed at the left and right sides of the front portion of the autonomous mobile device in a left-right symmetric manner, and are located at rear locations with respect to the first receiver s1 and the second receiver s2, respectively, along the circumference of the autonomous mobile device. The fifth receiver s5 and the sixth receiver s6 are disposed at the left and right sides of the rear portion of the autonomous mobile device in a left-right symmetric manner Therefore, illustratively, the moving angular velocities indicated by the output signals corresponding to the first receiver s1 and the second receiver s2 receiving the Z signal may be configured to be the same. The moving angular velocities indicated by the output signals corresponding to the third receiver s3 and the fourth receiver s4 receiving the Z signal may be configured to be the same, and may be greater than the moving angular velocity corresponding to the first receiver s1 and the second receiver s2. The angular velocities indicated by the output signals corresponding to the fifth receiver s5 and the sixth receiver s6 receiving the Z signal may be configured to be the same, and may be greater than the moving angular velocity corresponding to the third receiver s3 and the fourth receiver s4. As such, a receiver located closer to the rear portion of the autonomous mobile device may correspond to a larger output signal when receiving the first guidance signal (i.e., the Z signal), which means the corresponding moving angular velocity may be greater. The consequence is, if a portion that is closer to the rear portion of the autonomous mobile device faces the Z signal (therefore, the receiver located at the rear portion can receive the Z signal), the autonomous mobile device may rotate more quickly such that its front portion can more quickly face the coverage zone of the Z signal. For receivers disposed at left-right symmetric locations, the moving angular velocities indicated by the output signals corresponding to the receivers receiving the Z signal may be the same, and the symmetry of the moving behavior of the autonomous mobile device can be maintained.

In a possible implementation of this embodiment, the predetermined movement rules may be those shown in Table 4. The positive or negative sign in the output signals and the meaning of the output values are the same as those described in the above embodiment, which are not repeated.

TABLE 4

| | Re- | Re- | Re- | Re- | Re- | Re- |
|---|---|---|---|---|---|---|
| | ceiver | ceiver | ceiver | ceiver | ceiver | ceiver |
| | s1 | s2 | s3 | s4 | s5 | s6 |
| First | +100 | −100 | +120 | −120 | +150 | −150 |
| guidance | | | | | | |
| signal | | | | | | |
| (Z signal) | | | | | | |

Illustratively, the processes of the autonomous mobile device moving according to the predetermined movement rules of Table 4 are shown in FIGS. 7a-7d.

Specifically, if the autonomous mobile device is at the location shown in FIG. 7a, its moving behavior may be similar to that shown in FIG. 4d. That is, the receiver s1 may not receive the Z signal, and only the receiver s2 receives the Z signal (at this moment, the receivers s4 and s6 disposed at the same side as the receiver s2 may be blocked by the autonomous mobile device, and may not receive the Z signal). According to Table 4, the output value of −100 instructs the autonomous mobile device to move forwardly while rotating clockwise, at a moving angular velocity of 100k. Thus, the autonomous mobile device moves forwardly toward the coverage zone of the Z signal.

When the autonomous mobile device rotates clockwise to the location shown in FIG. 7b, only the receiver s1 receives the Z signal (at this moment the receivers s2, s4, and s6 are blocked by the autonomous mobile device; the receivers s3 and s5 are outside of the coverage scope of the Z signal). The moving behavior of the autonomous mobile device may be similar to that shown in FIG. 4a, i.e., the output value corresponding to the receiver s1 may be +100, and the moving angular velocity may be 100k. The autonomous mobile device may move forwardly while rotating counter-clockwise, such that the forward moving direction aims at the charging base when the autonomous mobile device approaches the charging base.

If the receivers s1 and s2 of the autonomous mobile device both receive the Z signal, at this moment, all of the receivers s3, s4, s5, and s6 may be blocked by the autonomous mobile device and may not receive the Z signal. The moving behavior of the autonomous mobile device may be similar to that shown in FIG. 4b. At this moment, the output values of the receivers s1 and s2 may have the same magnitude and opposite directions. The vector sum may instruct the autonomous mobile device to move straightly toward the charging base. The subsequent moving behavior may be the same as or similar to that shown in FIG. 4b, which is not repeated.

If the autonomous mobile device is at the location shown in FIG. 7c, at this moment, only the receiver s3 receives the Z signal. According to Table 4, the corresponding output value is +120, i.e., the autonomous mobile device moves forwardly while rotating counter-clockwise, such that the forward moving direction of the autonomous mobile device aims at the charging base, and the autonomous mobile device moves toward the charging base in a direction facing the charging base.

If the autonomous mobile device is at the location shown in FIG. 7d, at this moment, only the receiver s5 receives the Z signal. According to Table 4, the output value is +150, i.e., the autonomous mobile device moves forwardly while rotating counter-clockwise. Because the magnitude of the output value may be proportional to the angular velocity, then at this moment, the output value corresponding to the receiver s5 may indicate a moving angular velocity of 150k, which is greater than the moving angular velocities (100k and 120k respectively) indicated by the output values corresponding to the receivers s1 and s3 receiving the Z signal. Therefore, the autonomous mobile device may turn at a greater angular velocity toward the charging base. Finally, under the instructions of the vector sum of the output signals corresponding to the six receivers receiving the Z signal, the autonomous mobile device rotates toward the center of the charging base and approaches the charging base, thereby realizing fast and accurate charging of the autonomous mobile device.

It should be noted that because two groups of receivers are disposed on the autonomous mobile device in a left-right symmetric manner, when the autonomous mobile device moves to locations that are symmetric to the locations described above, the movements are not repeatedly described herein.

In some embodiments, the autonomous mobile device may be provided with four receivers, and the configuration of the four receivers may be shown in FIG. 2f. The four receivers include the receivers s1, s2 that are disposed on the left side and the right side at the front portion of the autonomous mobile device, respectively, and the receivers s5, s6 that are disposed at the left side and the right side of the rear portion of the autonomous mobile device, respectively. The predetermined movement rules for the four receivers receiving the Z signal may be similar to the predetermined movement rules for the receivers described in the above embodiment and shown in Table 4, which are not repeated.

In one or more possible embodiments, four additional receivers may be added to the embodiment shown in FIGS. 6a-6c, or, four additional guidance signals may be added to the embodiment shown in FIGS. 7a-7d. Descriptions will be provided next for the example in which the autonomous mobile device includes six receivers s1, s2, s3, s4, s5, and s6, and the charging base includes five transmitters configured to transmit five guidance signals Z, A, B, C, and E.

In this embodiment, the structure in which the autonomous mobile device is provided with six receivers s1, s2, s3, s4, s5, and s6 is shown in FIG. 2c. The coverage effects of the five guidance signals, the Z, A, B, C, E signals transmitted by the charging base are shown in FIG. 3c.

In a possible implementation of this embodiment, in addition to the predetermined movement rules included in the embodiment shown in FIGS. 6a-6c, the predetermined movement rules may also include at least one of the following rules: the moving directions indicated by the output signals corresponding to the first receiver s1 and the third receiver s3 receiving the same guidance signal may be the same; the moving directions indicated by the output signals corresponding to the second receiver s2 and the fourth receiver s4 receiving the same guidance signal may be the same; when the first receiver s1, the second receiver s2, the third receiver s3, or the fourth receiver s4 receives the second guidance signal (the A signal) or the fourth guidance signal (the C signal), all of the moving directions indicated by the corresponding output signals are the clockwise direction; when the first receiver s1, the second receiver s2, the third receiver s3, or the fourth receiver s4 receives the third guidance signal (the B signal) or the fifth guidance signal (the E signal), all of the moving directions indicated by the corresponding output signals are the counter-clockwise direction; when the fifth receiver s5 receives any of the guidance signals, the moving direction indicated by the corresponding output signal is the counter-clockwise direction; when the sixth receiver s6 receives any of the guidance signals, the moving direction indicated by the corresponding output signal is the clockwise direction.

In this embodiment, when the four receivers (s1, s2, s3, s4) located at the front portion of the autonomous mobile device receive the second guidance signal (A signal) or the fourth guidance signal (C signal), the autonomous mobile device may rotate clockwise, such that the autonomous mobile device turns to face the first guidance signal (Z signal); similarly, when the four receivers (s1, s2, s3, s4) receive the third guidance signal (B signal) or the fifth guidance signal (E signal), the autonomous mobile device may rotate counter-clockwise, such that the autonomous mobile device turns to face the first guidance signal (Z signal). Further, in this embodiment, all of the moving directions indicated by the output signals corresponding to the receiver s5 receiving the five guidance signals are the counter-clockwise direction, and all of the moving directions indicated by the output signals corresponding to the receiver s6 receiving the five guidance signals are the clockwise direction. The reason is: when the fifth receiver s5 and the sixth receiver s6 located at the rear portion of the autonomous mobile device receive the guidance signal, it indicates that at this moment, the autonomous mobile device faces away from the charging base, and the angle of the moving direction of the autonomous mobile device deviating from the Z signal direction of the charging base is overly large. Therefore, the autonomous mobile device needs to quickly adjust its moving direction such that the autonomous mobile device faces the charging base.

Further, the predetermined movement rules may specifically include: when the first receiver s1, the third receiver s3 receive the first guidance signal (Z signal), the third guidance signal (B signal), or the fifth guidance signal (E signal), the moving directions indicated by the corresponding output signals are the same, all being the counter-clockwise direction; when the first receiver s1 and the third receiver s3 receive the second guidance signal (A signal) and the fourth guidance signal (C signal), the moving directions indicated by the corresponding output signals are the same, all being the clockwise direction; when the second receiver s2 and the fourth receiver s4 receive the first guidance signal (Z signal), the second guidance signal (A signal), or the fourth guidance signal (C signal), the moving directions indicated by the corresponding output signals are the same, all being the clockwise direction; when the second receiver s2 and the fourth receiver s4 receive the third guidance signal (B signal) and the fifth guidance signal (E signal), the moving directions indicated by the corresponding output signals are the same, all being the counter-clockwise direction; when the fifth receiver s5 receives any of the five guidance signals, the moving direction indicated by the corresponding output signal is the counter-clockwise direction; when the sixth receiver s6 receives any of the five guidance signals, the moving direction indicated by the corresponding output signal is the clockwise direction.

In a possible implementation of this embodiment, the fifth receiver s5 and the sixth receiver s6 may be disposed on the autonomous mobile device at left-right symmetric locations. The predetermined movement rules may also include: the moving angular velocity indicated by the output signal corresponding to the fifth receiver s5 when the fifth receiver s5 receives the first guidance signal (Z signal) is the same as the moving angular velocity indicated by the output signal corresponding to the sixth receiver s6 when the sixth receiver s6 receives the first guidance signal (Z signal); the moving angular velocity indicated by the output signal corresponding to the fifth receiver s5 when the fifth receiver s5 receives the second guidance signal (A signal) is the same as the moving angular velocity indicated by the output signal corresponding to the sixth receiver s6 when the sixth receiver s6 receives the third guidance signal (B signal); the moving angular velocity indicated by the output signal corresponding to the fifth receiver s5 when the fifth receiver s5 receives the third guidance signal (B signal) is the same as the moving angular velocity indicated by the output signal corresponding to the sixth receiver s6 when the sixth receiver s6 receives the second guidance signal (A signal).

Illustratively, to ensure that the autonomous mobile device can quickly approach the charging base under the instructions of the output signals corresponding to the six receivers, the magnitude of the output value corresponding to each receiver receiving different guidance signals may need to satisfy predetermined rules. Specifically, the output signals corresponding to each receiver receiving the guidance signal may be those shown in Table 5.1. Based on the embodiment shown in FIGS. 6a-6c, when the receiver s1 and the receiver s2 receive the first guidance signal (Z signal), the output values corresponding to the receivers s1 and s2 may be a first angular velocity and a second angular velocity, respectively, where the first angular velocity may be the same as the second angular velocity. When the receiver s3 and the receiver s4 receive the first guidance signal (Z signal), the output values corresponding to the receiver s3 and the receiver s4 may be the same, which may be the third angular velocity described in the above embodiment, and which may be greater than the first angular velocity. When the receiver s5 and the receiver s6 receive the first guidance signal (Z signal), the output values corresponding to the receiver s5 and the receiver s6 may be the same, which may be the fourth angular velocity in the above embodiment, and the fourth angular velocity may be greater than the third angular velocity. When the receiver s3 and the receiver s5 receive the second guidance signal (A signal) and the fourth guidance signal (C signal), the output values may be the same as the output values corresponding to the receiver s4 and the receiver s6 receiving the third guidance signal (B signal) and the fifth guidance signal (E signal), which may be an eleventh angular velocity, and the eleventh angular velocity may be smaller than the first angular velocity. When the receiver s3 and the receiver s5 receive the third guidance signal (B signal) and the fifth guidance signal (E signal), the output values may be the same as the output values corresponding to the receiver s4 and the receiver s6 receiving the second guidance signal (A signal) and the fourth guidance signal (C signal), which may be a twelfth angular velocity, and the twelfth angular velocity may be greater than the fourth angular velocity.

TABLE 5.1

| | s1 | s2 | s3 | s4 | s5 | s6 |
|---|---|---|---|---|---|---|
| First | First | Second | Third | Third | Fourth | Fourth |
| guidance | angular | angular | angular | angular | angular | angular |
| signal | velocity | velocity | velocity | velocity | velocity | velocity |
| (Z signal) | | | | | | |
| Second | Third | Fourth | Elev- | Twelfth | Elev- | Twelfth |
| guidance | angular | angular | enth | angular | enth | angular |
| signal | velocity | velocity | angular | velocity | angular | velocity |
| (A signal) | | | velocity | | velocity | |
| Third | Fifth | Sixth | Twelfth | Elev- | Twelfth | Elev- |
| guidance | angular | angular | angular | enth | angular | enth |
| signal | velocity | velocity | velocity | angular | velocity | angular |
| (B signal) | | | | velocity | | velocity |
| Fourth | Seventh | Eighth | Elev- | Twelfth | Elev- | Twelfth |
| guidance | angular | angular | enth | angular | enth | angular |
| signal | velocity | velocity | angular | velocity | angular | velocity |
| (C signal) | | | velocity | | velocity | |
| Fifth | Ninth | Tenth | Twelfth | Elev- | Twelfth | Elev- |
| guidance | angular | angular | angular | enth | angular | enth |
| signal | velocity | velocity | velocity | angular | velocity | angular |
| (E signal) | | | | velocity | | velocity |

In a possible implementation of this embodiment, the predetermined movement rules may be those shown in Table 5.2. The positive and negative signs in the output signals shown in the table and the meaning of the output values may be the same as the above embodiment, which are not repeated.

TABLE 5.2

| | Re- | Re- | Re- | Re- | Re- | Re- |
|---|---|---|---|---|---|---|
| | ceiver | ceiver | ceiver | ceiver | ceiver | ceiver |
| | s1 | s2 | s3 | s4 | s5 | s6 |
| First | +100 | −100 | +120 | −120 | +150 | −150 |
| guidance | | | | | | |
| signal | | | | | | |
| (Z signal) | | | | | | |
| Second | −120 | −150 | −80 | −200 | +80 | −200 |
| guidance | | | | | | |
| signal | | | | | | |
| (A signal) | | | | | | |
| Third | +150 | +120 | +200 | +80 | +200 | −80 |
| guidance | | | | | | |
| signal | | | | | | |
| (B signal) | | | | | | |
| Fourth | −120 | −150 | −80 | −200 | +80 | −200 |
| guidance | | | | | | |
| signal | | | | | | |
| (C signal) | | | | | | |
| Fifth | +150 | +120 | +200 | +80 | +200 | −80 |
| guidance | | | | | | |
| signal | | | | | | |
| (E signal) | | | | | | |

Illustratively, as shown in Table 5.2, when two symmetrically disposed receivers (e.g., receiver s1 and receiver s2, receiver s3 and receiver s4, receiver s5 and receiver s6) receive the Z signal, the output values may have the same magnitude and opposite directions. Relative to Table 3.2 and Table 4, in Table 5.2, output values corresponding to the receivers s3, s4, s5, and s6 respectively receiving the guidance signals A, B, C, E are added. The directions of the output values corresponding to the receivers s3, s5 receiving the Z signal may be the same as the direction of the output value corresponding to the receiver s1 receiving the Z signal. The magnitudes of the output values corresponding to the receivers s1, s3, and s5 respectively receiving the Z signal may gradually increase. The directions of the output values corresponding to the receiver s4, s6 receiving the Z signal may be the same as the direction of the output value corresponding to the receiver s2 receiving the Z signal. The magnitudes of the output values corresponding to the receivers s2, s4, and s6 respectively receiving the Z signal may gradually increase. As such, the moving behavior of the receivers disposed on the same side of the autonomous mobile device (e.g., receivers s1, s3, and s5, or receivers s2, s4, and s6) may be the same (e.g., same rotating direction). In addition, the moving angular velocity indicated by the output signal corresponding to a receiver may be greater when the receiver is disposed closer to the rear portion of the autonomous mobile device, such that the autonomous mobile device may quickly adjust its pose to approach the coverage zone of the center signal, i.e., the Z signal. It should be noted that the various situations of the autonomous mobile device moving according to the predetermined movement rules shown in Table 5.2 may refer to the detailed descriptions of the two embodiments shown in FIGS. 6a-6c and FIGS. 7a-7d, which are not repeated.

In one or more possible embodiments, based on the above embodiment, the autonomous mobile device may be provided with two additional receivers. Next, descriptions will be provided to an example in which the autonomous mobile device is provided with eight receivers, and the charging base is configured to transmit five guidance signals.

In this embodiment, the configuration of the eight receivers on the autonomous mobile device is shown in FIG. 2d, and the coverage effects of the five guidance signals transmitted by the charging base is shown in FIG. 3c.

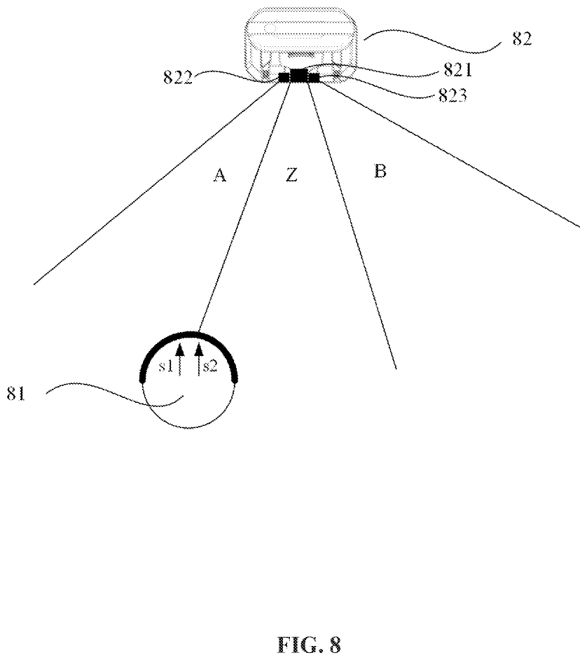

In a possible implementation of this embodiment, in addition to the predetermined movement rules of the embodiment shown in FIG. 8, the predetermined movement rules may also include at least one of the following rules: when the seventh receiver s7 receives any of the guidance signals, the moving direction indicated by the corresponding output signal is the counter-clockwise direction; when the eighth receiver s8 receives any of the guidance signals, the moving direction indicated by the corresponding output signal is the clockwise direction; and/or, when the seventh receiver s7 receives any of the guidance signals, the moving angular velocity indicated by the corresponding output signal is greater than the moving angular velocity indicated by the corresponding output signal when the fifth receiver s5 receives the same guidance signal; when the eighth receiver s8 receives any of the guidance signals, the moving angular velocity indicated by the corresponding output signal is greater than the moving angular velocity indicated by the corresponding output signal when the sixth receiver s6 receives the same guidance signal.

In this embodiment, the purpose of setting the seventh receiver s7 and the eighth receiver s8 may be the same as the purpose of setting the fifth receiver s5 and the sixth receiver s6 in the above embodiment. When the seventh receiver s7 and the eighth receiver s8 disposed at the rear portion of the autonomous mobile device receives the guidance signal, it indicates that at this moment, the autonomous mobile device may face away from the charging base, and the angle of the moving direction of the autonomous mobile device deviating from the Z signal direction of the charging base is overly large. Therefore, the autonomous mobile device needs to quickly adjust its moving direction such that the autonomous mobile device faces the charging base.

Illustratively, to ensure that the autonomous mobile device can quickly approach the charging base under the instructions of the output signals corresponding to the eight receivers, the magnitudes of the output values corresponding to each receiver receiving different guidance signals may need to satisfy predetermined rules. Specifically, the output signals corresponding to each receiver receiving the guidance signals may be those shown in Table 6.1. Based on the embodiment shown in FIG. 8, when the seventh receiver s7 and the eighth receiver s8 receive the Z signal, the output values corresponding to the receivers s7 and s8 may be the same, which may be a thirteenth angular velocity, and the thirteenth angular velocity may be greater than the output value (i.e., the fourth angular velocity) corresponding to the fifth receiver s5 and the sixth receiver s6 receiving the Z signal. When the seventh receiver s7 receives the A signal or the C signal, the output values may be the same as the output values corresponding to the eighth receiver s8 receiving the B signal or the E signal, which may be a fourteenth angular velocity, and the fourteenth angular velocity may be greater than the output value (i.e., the twelfth angular velocity) corresponding to the fifth receiver s5 receiving the B signal or the E signal. The output values corresponding to the eighth receiver s8 receiving the A signal or the C signal may be the same, which may be the fourteenth angular velocity. As such, when all of the receivers (s1, s3, s5, and s7) disposed at the left side of the autonomous mobile device receive the Z signal, B signal, or E signal, the output value corresponding to the seventh receiver s7 has the maximum magnitude. In addition, when all of the receivers (s2, s4, s6, and s8) disposed at the right side of the autonomous mobile device receive the Z signal, A signal, or C signal, the output value corresponding to the eighth receiver s8 has the maximum magnitude.

TABLE 6.1

| | s1 | s2 | s3 | s4 | s5 | s6 | s7 | s8 |
|---|---|---|---|---|---|---|---|---|
| First | 1^{st} | 2^{nd} | 3^{rd} | 3^{rd} | 4^{th} | 4^{th} | 13^{th} | 13^{th} |
| guidance | angular | angular | angular | angular | angular | angular | angular | angular |
| signal | velocity | velocity | velocity | velocity | velocity | velocity | velocity | velocity |
| (Z signal) | | | | | | | | |
| Second | 3^{rd} | 4^{th} | 11^{th} | 12^{th} | 11^{th} | 12^{th} | | 14^{th} |
| guidance | angular | angular | angular | angular | angular | angular | | angular |
| signal | velocity | velocity | velocity | velocity | velocity | velocity | | velocity |
| (A signal) | | | | | | | | |
| Third | 5^{th} | 6^{th} | 12^{th} | 11^{th} | 12^{th} | 11^{th} | 14^{th} | |
| guidance | angular | angular | angular | angular | angular | angular | angular | |
| signal | velocity | velocity | velocity | velocity | velocity | velocity | velocity | |
| (B signal) | | | | | | | | |
| Fourth | 7^{th} | 8^{th} | 11^{th} | 12^{th} | 11^{th} | 12^{th} | | 14^{th} |
| guidance | angular | angular | angular | angular | angular | angular | | angular |
| signal | velocity | velocity | velocity | velocity | velocity | velocity | | velocity |
| (C signal) | | | | | | | | |
| Fifth | 9^{th} | 10^{th} | 12^{th} | 11^{th} | 12^{th} | 11^{th} | 14^{th} | |
| guidance | angular | angular | angular | angular | angular | angular | angular | |
| signal | velocity | velocity | velocity | velocity | velocity | velocity | velocity | |
| (E signal) | | | | | | | | |

In a possible implementation of this embodiment, the predetermined movement rules may be those shown in Table 6.2. The positive and negative signs in the output signals shown in the table and the meaning of the output values may be the same as the above embodiment, which are not repeated.

TABLE 6.2

| | s1 | s2 | s3 | s4 | s5 | s6 | s7 | s8 |
|---|---|---|---|---|---|---|---|---|
| First | +100 | −100 | +120 | −120 | +150 | −150 | +180 | −180 |
| guidance | | | | | | | | |
| signal | | | | | | | | |
| (Z signal) | | | | | | | | |
| Second | −120 | −150 | −80 | −200 | +80 | −200 | +100 | −240 |
| guidance | | | | | | | | |
| signal | | | | | | | | |
| (A signal) | | | | | | | | |
| Third | +150 | +120 | +200 | +80 | +200 | −80 | +240 | −100 |
| guidance | | | | | | | | |
| signal | | | | | | | | |
| (B signal) | | | | | | | | |
| Fourth | −120 | −150 | −80 | −200 | +80 | −200 | +100 | −240 |
| guidance | | | | | | | | |
| signal | | | | | | | | |
| (C signal) | | | | | | | | |
| Fifth | +150 | +120 | +200 | +80 | +200 | −80 | +240 | −100 |
| guidance | | | | | | | | |
| signal | | | | | | | | |
| (E signal) | | | | | | | | |

It should be noted that, various situations of the autonomous mobile device moving according to the predetermined movement rules shown in Table 6.2 may be similar to those described in the above embodiment, which are not repeated.

In one or more possible embodiments, the autonomous mobile device may be provided with four receivers. The configuration of the four receivers is shown in FIG. 2b. The movement rules under the situations of the four receivers receiving the five guidance signals transmitted by the five transmitters on the charging base, may be the same as the movement rules of the receivers s1, s2, s3, and s4 receiving the five guidance signals as shown in Table 5.2 or Table 6.2, which are not repeated.

FIG. 8 is a schematic illustration of a structure of an autonomous mobile device system, according to an illustrative embodiment of the present disclosure.

As shown in FIG. 8, the system of this embodiment may include: an autonomous mobile device 81 and a charging base 82. The charging base 82 may be provided with at least three transmitters (a first transmitter 821, a second transmitter 822, and a third transmitter 823) configured to transmit directional guidance signals. The first transmitter 821, the second transmitter 822, and the third transmitter 823 may transmit the first guidance signal (Z signal), the second guidance signal (A signal), and the third guidance signal (B signal), respectively. A projection of the second guidance signal (A signal) on a horizontal plane and a projection of the third guidance signal (B signal) on the horizontal plane may be located at two sides of a projection of the first guidance signal (Z signal) on the horizontal plane, respectively. The autonomous mobile device may be provided with at least two receivers configured to receive the guidance signals. The at least two receivers may be disposed at two sides of the autonomous mobile device respectively, such that each of the two sides of the autonomous mobile device has at least one receiver.

In a possible embodiment, the charging base may be provided with a fourth transmitter and a fifth transmitter. The fourth transmitter and the fifth transmitter may be configured to transmit the fourth guidance signal and the fifth guidance signal, respectively. The fourth guidance signal may be located at the left side of the second guidance signal, and the fifth guidance signal may be located at the right side of the third guidance signal.

In a possible embodiment, the second guidance signal may be located at the left side of the first guidance signal, and the third guidance signal may be located at the right side of the first guidance signal. The at least two receivers may include a first receiver and a second receiver disposed at the left side and the right side of the front portion of the autonomous mobile device, respectively.

The at least two receivers may also include a third receiver and a fourth receiver. The third receiver may be disposed at the front left side of the autonomous mobile device, and may be located at a rear location with respect to the first receiver along the circumference of the autonomous mobile device. The fourth receiver may be disposed at the front right side of the autonomous mobile device, and may be located at a rear location with respect to the second receiver along the circumference of the autonomous mobile device.

In a possible embodiment, the at least two receivers may also include a fifth receiver and a sixth receiver. The fifth receiver may be disposed at the rear left side of the autonomous mobile device. The sixth receiver may be disposed at the rear right side of the autonomous mobile device.

In a possible embodiment, the at least two receivers may also include: a seventh receiver and an eighth receiver. The seventh receiver may be disposed at the rear left side of the autonomous mobile device, and may be located at a rear location with respect to the fifth receiver along the circumference of the autonomous mobile device. The eighth receiver may be disposed at the rear right side of the autonomous mobile device, and may be located at a rear location with respect to the sixth receiver along the circumference of the autonomous mobile device.

It should be noted that, in this embodiment, descriptions of the functions of the various devices or components included in the autonomous mobile device system can refer to the above descriptions of the methods, which are not repeated.

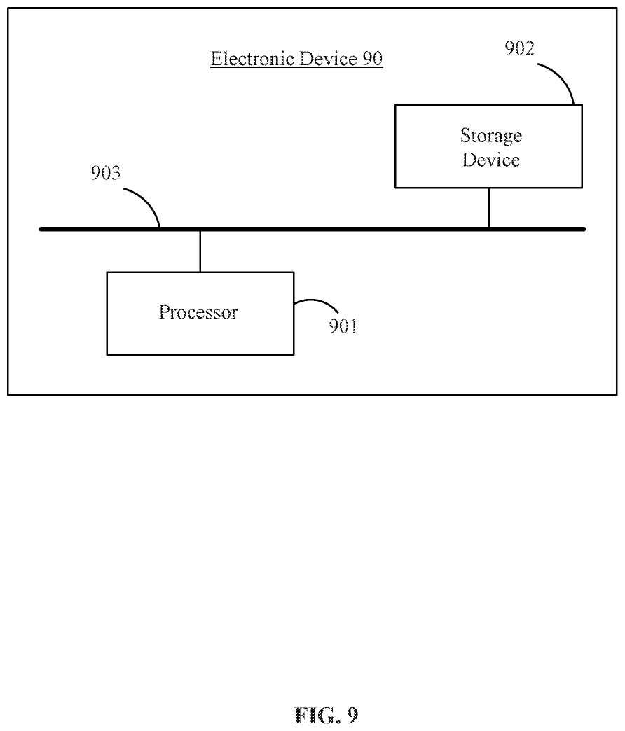

FIG. 9 is a schematic illustration of a hardware structure of an electronic device according to an embodiment of the present disclosure. As shown in FIG. 9, an electronic device 90 of this embodiment may include: at least one processor 901 and a storage device 902. The processor 901 and the storage device 902 may be connected with one another through a bus 903.

In some embodiments, the at least one processor 901 may execute computer-executable instructions stored in the storage device 902, such that the at least one processor 901 may execute the automatic recharging method for the autonomous mobile device that is described in the above embodiment.

Detailed implementation of the processor 901 can refer to the above embodiment of the method. The principle and technical effects are similar, which are not repeated.

In the embodiment shown in FIG. 9, it should be understood that the processor may be a Central Processing Unit (CPU), or may be other general processor, Digital Signal Processor (DSP), Application Specific Integrated Circuit (ASIC), etc. The general processor may be a micro-processor or any other regular processor, etc. The steps of the method disclosed herein may be directly executed by the hardware processor, or may be executed by a combination of hardware and software components included in the processor.

The storage device may include a high-speed Random Access Memory (RAM), or may include non-volatile memory (NVM). For example, in some embodiments, the storage device may include at least one magnetic storage device.

The bus may be an Industry Standard Architecture (ISA) bus, a Peripheral Component Interconnect (PCI) bus, or an Extended Industry Standard Architecture (EISA) bus, etc. The bus may be an address bus, a data bus, a control bus, etc. For convenience, the bus shown in the figure is not limited to one bus or a specific type of bus.

Another embodiment of the present disclosure provides a non-transitory computer-readable storage medium. The non-transitory computer-readable storage medium may storage computer-executable instructions. When the processor executes the computer-executable instructions, the automatic recharging method for the autonomous mobile device described in the above embodiment may be executed.

The computer-readable storage medium may be any volatile or non-volatile storage device or any combination thereof. For example, the computer-readable storage medium may be a static random-access memory (SRAM), an electrically erasable programmable read-only memory (EEPROM), an erasable programmable read-only memory (EPROM), a programmable read-only memory (PROM), a read-only memory (ROM), a magnetic storage device, a flash storage device, a magnetic disk or an optic disk. The computer-readable storage medium may be any suitable medium that may be used for data storage in a general-purpose or specific-purpose computer.

An illustrative computer-readable storage medium may be coupled with the processor, such that the processor may retrieve information from the computer-readable storage medium, and may write information into the computer-readable storage medium. In some embodiments, the computer-readable storage medium may be part of the processor. The processor and the computer-readable storage medium may be included in an Application Specific Integrated Circuit (ASIC). In some embodiments, the processor and the computer-readable storage medium may be included in the device as separate components.

A person having ordinary skills in the art can appreciate, all or some steps of the method in the above embodiments may be realized through computer program instructing relevant hardware. The program may be stored in a computer-readable storage medium. When the program is executed, the steps of the method in the above embodiments may be executed. The storage medium may include: ROM, RAM, magnetic disk or optic disk, or any other medium that may be used to storage computer program codes.

Finally, it should be noted that: the above embodiments are only used to explain the technical solutions of the present disclosure, and are not to limit the present disclosure; although detailed explanations have been provided for the present disclosure with reference to the above various embodiments, a person having ordinary skills in the art should understand: the person having ordinary skills in the art can modify the technical solutions described in the above various embodiments, or carry out equivalent replacement to some or all technical features. These modifications or replacements do not render relevant technical solutions to deviate from the scope of the technical solutions of various embodiments of the present disclosure.

What is claimed is:

1. An automatic recharging method for an autonomous mobile device, comprising:
receiving, by at least two receivers disposed at a front left side and a front right side of the autonomous mobile device respectively, guidance signals transmitted by at least three transmitters of a charging base, wherein the guidance signals include a first guidance signal, a second guidance signal, and a third guidance signal;
determining output signals corresponding to the at least two receivers based on predetermined movement rules and the guidance signals received by the at least two receivers, wherein the predetermined movement rules include output signals corresponding to each receiver when each receiver receives different guidance signals;
performing a vector composition on the output signals corresponding to the at least two receivers to obtain a vector sum; and
controlling movement of the autonomous mobile device based on the vector sum.

2. The method of claim 1, wherein the at least two receivers include a first receiver and a second receiver, and wherein the predetermined movement rules include:
when the first receiver disposed at the front left side of the autonomous mobile device receives the first guidance signal having a coverage zone that is a center zone in front of the charging base, an output signal corresponding to the first receiver indicates a moving direction that is a counter-clockwise direction and a moving angular velocity that is a first angular velocity;
when the second receiver disposed at the front right side of the autonomous mobile device receives the first guidance signal, an output signal corresponding to the second receiver indicates a moving direction that is a clockwise direction and a moving angular velocity that is a second angular velocity;
when the first receiver receives the second guidance signal, whose projection on a horizontal plane is located at a first side of a projection of the first guidance signal on the horizontal plane, an output signal corresponding to the first receiver indicates a moving direction that is a clockwise direction and a moving angular velocity that is a third angular velocity;
when the second receiver receives the second guidance signal, an output signal corresponding to the second receiver indicates a moving direction that is a clockwise direction and a moving angular velocity that is a fourth angular velocity;
when the first receiver receives the third guidance signal, whose projection on the horizontal plane is located at a second side of the projection of the first guidance signal on the horizontal plane, an output signal corresponding to the first receiver indicates a moving direction that is a counter-clockwise direction and a moving angular velocity that is a fifth angular velocity; and
when the second receiver receives the third guidance signal, an output signal corresponding to the second receiver indicates a moving direction that is a counter-clockwise direction and a moving angular velocity that is a sixth angular velocity.

3. The method of claim 2, wherein predetermined movement rules also include:
the first angular velocity is the same as the second angular velocity;
the third angular velocity is the same as the sixth angular velocity; and
the fourth angular velocity is the same as the fifth angular velocity.

4. The method of claim 2, wherein the at least three transmitters on the charging base are also configured to transmit a fourth guidance signal and a fifth guidance signal, and wherein the predetermined movement rules also include:
when the first receiver receives the fourth guidance signal, which is located at one of two sides of the second guidance signal that is farther away from the first guidance signal, an output signal corresponding to the first receiver indicates a moving direction that is a clockwise direction and a moving angular velocity that is a seventh angular velocity;
when the second receiver receives the fourth guidance signal, an output signal corresponding to the second receiver indicates a moving direction that is a clockwise direction and a moving angular velocity that is an eighth angular velocity;
when the first receiver receives the fifth guidance signal, which is located at one of two sides of the third guidance signal that is farther away from the first guidance signal, an output signal corresponding to the first receiver indicates a moving direction that is a counter-clockwise direction and a moving angular velocity that is a ninth angular velocity; and
when the second receiver receives the fifth guidance signal, an output signal corresponding to the second receiver indicates a moving direction that is a counter-clockwise direction and a moving angular velocity that is a tenth angular velocity.

5. The method of claim 4, wherein the at least two receivers also include a third receiver and a fourth receiver, and wherein the predetermined movement rules also include:
when the first receiver and the third receiver, which is disposed at the front left side of the autonomous mobile device and is located at a rear location with respect to the first receiver along a circumference of the autonomous mobile device, receive the same guidance signal, moving directions indicated by output signals corresponding the first receiver and the third receiver are the same, when the second receiver and the fourth receiver, which is disposed at the front right side of the autonomous mobile device and is located at a rear location with respect to the second receiver along the circumference of the autonomous mobile device, receive the same guidance signal, moving directions indicated by output signals corresponding to second receiver and the fourth receiver are the same.

6. The method of claim 5, wherein the predetermined movement rules also include:
when the first receiver, the second receiver, the third receiver, or the fourth receiver receives the second guidance signal or the fourth guidance signal, a moving direction indicated by a corresponding output signal is the clockwise direction; and
when the first receiver, the second receiver, the third receiver, or the fourth receiver receives the third guidance signal or the fifth guidance signal, a moving direction indicated by a corresponding output signal is the counter-clockwise direction.

7. The method of claim 2, wherein the at least two receivers also include a fifth receiver and a sixth receiver, and wherein the predetermined movement rules also include:
when the fifth receiver, which is disposed at a rear left side of the autonomous mobile device, receives the first guidance signal, the second guidance signal, the third guidance signal, the fourth guidance signal, or the fifth guidance signal, a moving direction indicated by a corresponding output signal is the counter-clockwise direction; and
when the sixth receiver, which is disposed at a rear right side of the autonomous mobile device, receives the first guidance signal, the second guidance signal, the third guidance signal, the fourth guidance signal, or the fifth guidance signal, a moving direction indicated a corresponding output signal is the clockwise direction.

8. The method of claim 7, wherein the at least two receivers also include a seventh receiver and an eighth receiver, and wherein the predetermined movement rules also include:
when the seventh receiver, which is disposed at a rear left side of the autonomous mobile device and is located at a rear location with respect to the fifth receiver along the circumference of the autonomous mobile device, receives the first guidance signal, the second guidance signal, the third guidance signal, the fourth guidance signal, or the fifth guidance signal, a moving direction indicated by a corresponding output signal is the counter-clockwise direction; and
when the eighth receiver, which is disposed at a rear right side of the autonomous mobile device and is located at a rear location with respect to the sixth receiver along the circumference of the autonomous mobile device, receives the first guidance signal, the second guidance signal, the third guidance signal, the fourth guidance signal, or the fifth guidance signal, a moving direction indicated by a corresponding output signal is the clockwise direction.

9. The method of claim 8, wherein the predetermined movement rules also include:
a moving angular velocity indicated by a corresponding output signal when the seventh receiver receives the first guidance signal, the second guidance signal, the third guidance signal, the fourth guidance signal, or the fifth guidance signal, is greater than a moving angular velocity indicated by a corresponding output signal when the fifth receiver receives the first guidance signal, the second guidance signal, the third guidance signal, the fourth guidance signal, or the fifth guidance signal; and
a moving angular velocity indicated by a corresponding output signal when the eighth receiver receives the first guidance signal, the second guidance signal, the third guidance signal, the fourth guidance signal, or the fifth guidance signal, is greater than a moving angular velocity indicated by a corresponding output signal when the sixth receiver receives the first guidance signal, the second guidance signal, the third guidance signal, the fourth guidance signal, or the fifth guidance signal.

10. The method of claim 7, wherein the predetermined movement rules also include:
when the fifth receiver receives the first guidance signal, a moving angular velocity indicated by an output signal corresponding to the fifth receiver is the same as a moving angular velocity indicated by an output signal corresponding to the sixth receiver when the sixth receiver receives the first guidance signal;
when the fifth receiver receives the second guidance signal, a moving angular velocity indicated by an output signal corresponding to the fifth receiver is the same as a moving angular velocity indicated by an output signal corresponding to the sixth receiver when the sixth receiver receives the third guidance signal; and
when the fifth receiver receives the third guidance signal, a moving angular velocity indicated by an output signal corresponding to the fifth receiver is the same as a moving angular velocity indicated by an output signal corresponding to the sixth receiver when the sixth receiver receives the second guidance signal.

11. The method of claim 1, wherein the at least two receivers include a first receiver and a second receiver, and wherein the predetermined movement rules include:
when the first receiver disposed at the front left side of the autonomous mobile device receives the first guidance signal having a coverage zone that is a center zone in front of the charging base, an output signal corresponding to the first receiver indicates a moving direction that is a counter-clockwise direction and a moving angular velocity that is a first angular velocity; and
when the second receiver disposed at the front right side of the autonomous mobile device receives the first guidance signal, an output signal corresponding to the second receiver indicates a moving direction that is a clockwise direction and a moving angular velocity that is a second angular velocity.

12. The method of claim 1,
wherein an output signal corresponding to a receiver refers to, when only the receiver receives a guidance signal, an output signal that indicates a moving direction and a moving angular velocity for the autonomous mobile device,
wherein the output signal corresponding to the receiver is represented by an output value having a positive or negative sign, the positive or negative sign represents the moving direction of the autonomous mobile device, and a magnitude of the output value is proportional to the moving angular velocity, and
wherein a direction of the vector sum indicates an overall moving direction of the autonomous mobile device, a magnitude of the vector sum is proportional to an overall moving angular velocity that indicates a next movement of the autonomous mobile device.

13. An autonomous mobile device system, comprising:
an autonomous mobile device and a charging base,
wherein the charging base includes at least three transmitters configured to transmit directional guidance signals,
wherein the guidance signals include a first guidance signal, a second guidance signal, and a third guidance signal,
wherein the at least three transmitters include a first transmitter, a second transmitter, and a third transmitter configured to transmit a first guidance signal, a second guidance signal, and a third guidance signal, respectively,
wherein a coverage zone of the first guidance signal is a center zone in front of the charging base, a projection of the second guidance signal on a horizontal plane and a projection of the third guidance signal on the horizontal plane are located at two sides of a projection of the first guidance signal on the horizontal plane,
wherein the autonomous mobile device includes at least two receivers configured to receive the guidance signals, and
wherein the at least two receivers are disposed at a front left side and a front right side of the autonomous mobile device.

14. The autonomous mobile device system of claim 13,
wherein the charging base also includes a fourth transmitter and a fifth transmitter,
wherein the fourth transmitter and the fifth transmitter are configured to transmit a fourth guidance signal and a fifth guidance signal, respectively,
wherein the fourth guidance signal is located at one of two sides of the second guidance signal that is farther away from the first guidance signal, and
wherein the fifth guidance signal is located at one of two sides of the third guidance signal that is farther away from the first guidance signal.

15. The autonomous mobile device system of claim 13,
wherein the second guidance signal is located at a left side of the first guidance signal, the third guidance signal is located at a right side of the first guidance signal,
wherein the at least two receivers include a first receiver and a second receiver disposed at the front left side and the front right side of the autonomous mobile device, respective,
wherein the at least two receivers also include a third receiver and a fourth receiver,
wherein the third receiver is disposed at the front left side of the autonomous mobile device, and is located at a rear location with respect to the first receiver along a circumference of the autonomous mobile device, and
wherein the fourth receiver is disposed at the front right side of the autonomous mobile device, and is located at a rear location with respect to the second receiver along the circumference of the autonomous mobile device.

16. The autonomous mobile device system of claim 14,
wherein the at least two receivers also include a fifth receiver and a sixth receiver,
wherein the fifth receiver is disposed at a rear left side of the autonomous mobile device, and
wherein the sixth receiver is disposed at a rear right side of the autonomous mobile device.

17. The autonomous mobile device system of claim 15,
wherein the at least two receivers also include a seventh receiver and an eighth receiver,
wherein the seventh receiver is disposed at the rear left side of the autonomous mobile device, and is located at a rear location with respect to the fifth receiver along the circumference of the autonomous mobile device, and
wherein the eighth receiver is disposed at the rear right side of the autonomous mobile device, and is located at a rear location with respect to the sixth receiver along the circumference of the autonomous mobile device.

18. A non-transitory computer-readable storage medium storing computer-executable instructions, which when executed by a processor of an autonomous mobile device, causes the processor to perform an automatic recharging method for the autonomous mobile device, wherein the automatic recharging method comprises:
receiving, from at least two receivers disposed at a front left side and a front right side of the autonomous mobile device respectively, guidance signals transmitted by at least three transmitters of a charging base, wherein the guidance signals include a first guidance signal, a second guidance signal, and a third guidance signal;
determining output signals corresponding to the at least two receivers based on predetermined movement rules and the guidance signals received by the at least two receivers, wherein the predetermined movement rules include output signals corresponding to each receiver when each receiver receives different guidance signals;
performing a vector composition on output signals corresponding to the at least two receivers to obtain a vector sum; and
controlling movement of the autonomous mobile device based on the vector sum.

19. The non-transitory computer-readable storage medium of claim 18, wherein the predetermined movement rules include:
when the first receiver disposed at the front left side of the autonomous mobile device receives the first guidance signal having a coverage zone that is a center zone in front of the charging base, an output signal corresponding to the first receiver indicates a moving direction that is a counter-clockwise direction and a moving angular velocity that is a first angular velocity;
when the second receiver disposed at the front right side of the autonomous mobile device receives the first guidance signal, an output signal corresponding to the second receiver indicates a moving direction that is a clockwise direction and a moving angular velocity that is a second angular velocity;
when the first receiver receives the second guidance signal, whose projection on a horizontal plane is located at a first side of a projection of the first guidance signal on the horizontal plane, an output signal corresponding to the first receiver indicates a moving direction that is a clockwise direction and a moving angular velocity that is a third angular velocity;
when the second receiver receives the second guidance signal, an output signal corresponding to the second receiver indicates a moving direction that is a clockwise direction and a moving angular velocity that is a fourth angular velocity;
when the first receiver receives the third guidance signal, whose projection on the horizontal plane is located at a second side of the projection of the first guidance signal on the horizontal plane, an output signal corresponding to the first receiver indicates a moving direction that is a counter-clockwise direction and a moving angular velocity that is a fifth angular velocity; and
when the second receiver receives the third guidance signal, an output signal corresponding to the second receiver indicates a moving direction that is a counter-clockwise direction and a moving angular velocity that is a sixth angular velocity.

20. The non-transitory computer-readable storage medium of claim 18, wherein the predetermined movement rules include:
the first angular velocity is the same as the second angular velocity;
the third angular velocity is the same as the sixth angular velocity; and
the fourth angular velocity is the same as the fifth angular velocity.
